(19) United States
(12) Patent Application Publication
(10) Pub. No.: US 2024/0404018 A1
(43) Pub. Date: Dec. 5, 2024

(54) IMAGE PROCESSING METHOD AND APPARATUS, DEVICE, STORAGE MEDIUM AND PROGRAM PRODUCT

(71) Applicant: TENCENT TECHNOLOGY (SHENZHEN) COMPANY LIMITED, Shenzhen (CN)

(72) Inventors: Wenhui HAN, Shenzhen (CN); Yandan Zhao, Shenzhen (CN); Ying Tai, Shenzhen (CN); Donghao Luo, Shenzhen (CN); Chengjie Wang, Shenzhen (CN)

(73) Assignee: TENCENT TECHNOLOGY (SHENZHEN) COMPANY LIMITED, Shenzhen (CN)

(21) Appl. No.: 18/800,385

(22) Filed: Aug. 12, 2024

Related U.S. Application Data
(63) Continuation of application No. PCT/CN2023/124165, filed on Oct. 12, 2023.

(30) Foreign Application Priority Data
Nov. 7, 2022 (CN) 202211390553.3

(51) Int. Cl. G06T 5/60; G06T 5/77; G06T 7/00; G06V 10/774; G06V 10/776; G06V 10/82; G06V 40/16

(52) U.S. Cl. CPC G06T 5/60; G06T 5/77; G06T 7/0012; G06V 10/774; G06V 10/776; G06V 10/82; G06V 40/161; G06V 40/168; G06T 2207/20081; G06T 2207/20084; G06T 2207/30088; G06T 2207/30201

(57) ABSTRACT

An image processing method, performed by a computer device, includes: obtaining an input image to be processed; performing face detection on the input image to obtain an input face image to be processed including at least one defect element relating to a skin element; and inputting the input face image into an image processing model to obtain a target face image corresponding to the input face image without a first defect element amongst the at least one defect element, wherein a training sample of the image processing model includes a first face image with a first face distortion degree less than a preset threshold and that is annotated with the first defect element.

### CROSS-REFERENCE TO RELATED APPLICATIONS

This application is a continuation application of International Application No. PCT/CN2023/124165 filed on Oct. 12, 2023, which claims priority to Chinese Patent Application No. 202211390553.3, filed with the China National Intellectual Property Administration on Nov. 7, 2022, the disclosures of each being incorporated by reference herein in their entireties.

### FIELD

The disclosure relates to the field of image processing technologies, and in particular, to an image processing method and apparatus, a device, a storage medium, and a program product.

### BACKGROUND

With the continuous development of computer technologies, image processing technologies may form the basis of practical technologies such as stereo vision, motion analysis, and data fusion, for example, which have been used in various fields, such as autonomous driving, image post-processing, map and terrain registration, natural resource analysis, environmental monitoring, and physiological pathology research. During application of the image post-processing, by virtue of image processing technologies, not only may some images be beautified, but also interference of noise on the image may sometimes be reduced or eliminated, thereby improving picture quality.

During image post-processing, a deep learning algorithm may be adopted to modify an attribute of a character image to obtain an image processing result.

However, the foregoing solutions may globally change pixels of the entire image, resulting in unnatural or one-sided processed images that may lack characteristics such as a skin texture of a real face, and may otherwise affect the picture quality.

### SUMMARY

Provided are an image processing method and apparatus, a device, a storage medium, and a program product, capable of performing image conversion on a face image to obtain a target face image without including defect region and with characteristics like those of a real face.

According to some embodiments, an image processing method, performed by a computer device, includes: obtaining an input image to be processed; performing face detection on the input image to obtain an input face image to be processed including at least one defect element relating to a skin element; and inputting the input face image into an image processing model to obtain a target face image corresponding to the input face image without a first defect element amongst the at least one defect element, wherein a training sample of the image processing model includes a first face image with a first face distortion degree less than a preset threshold and that is annotated with the first defect element.

According to some embodiments, an image processing apparatus, includes: at least one memory configured to store computer program code; and at least one processor configured to read the program code and operate as instructed by the program code, the program code including: obtaining code configured to cause at least one of the at least one processor to obtain an input image to be processed; detection code configured to cause at least one of the at least one processor to perform face detection on the input image to obtain an input face image to be processed including at least one defect element relating to a skin element; and image conversion code configured to cause at least one of the at least one processor to input the input face image into an image processing model to obtain a target face image corresponding to the input face image without a first defect element amongst the at least one defect element, wherein a training sample of the image processing model includes a first face image with a first face distortion degree less than a preset threshold and that is annotated with the first defect element.

According to some embodiments, a non-transitory computer-readable storage medium, storing computer code which, when executed by at least one processor, causes the at least one processor to at least: obtain an input image to be processed; perform face detection on the input image to obtain an input face image to be processed including at least one defect element relating to a skin element; and input the input face image into an image processing model to obtain a target face image corresponding to the input face image without a first defect element amongst the at least one defect element, wherein a training sample of the image processing model includes a first face image with a first face distortion degree less than a preset threshold and that is annotated with the first defect element.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a system architecture diagram of an application system for image processing according to some embodiments.

FIG. 2 is a schematic flowchart of an image processing method according to some embodiments.

FIG. 3 is a schematic diagram of an image processing process according to some embodiments.

FIG. 4 is a schematic flowchart of a method for determining an image processing model according to some embodiments.

FIG. 5 is a schematic diagram of training a generative adversarial model according to some embodiments.

FIG. 6 is a schematic diagram of training a generative adversarial model according to some embodiments.

FIG. 7 is a schematic diagram of training a generative adversarial model according to some embodiments.

FIG. 8 is a schematic diagram of training a generative adversarial model according to some embodiments.

FIG. 9 is a schematic diagram of training a generative adversarial model according to some embodiments.

FIG. 10 is a schematic diagram of a method for determining an image processing model according to some embodiments.

FIG. 11 is a schematic diagram of adding an element sample to a label image according to some embodiments.

FIG. 12 is a schematic flowchart of a method for performing image conversion on an image to be processed according to some embodiments.

FIG. 13 is a schematic diagram of a method for obtaining a training sample according to some embodiments.

FIG. 14 is a schematic diagram of a method for performing image conversion on a face image to be processed according to some embodiments.

FIG. 15 is a schematic diagram of comparison of a face image to be processed and a target face image according to some embodiments.

FIG. 16 is a schematic diagram of comparison of a face image to be processed and a target face image according to some embodiments.

FIG. 17 is a schematic structural diagram of an image recognition apparatus according to some embodiments.

FIG. 18 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

(1) Artificial Intelligence (AI): It is a theory, a method, a technology, and an application system that uses a digital computer or a machine controlled by the digital computer to simulate, extend, and expand human intelligence, perceive the environment, acquire knowledge, and use the knowledge to obtain the result.

The AI technology may involve a wide range of fields including both hardware-level technologies and software-level technologies. AI technologies may include technologies such as a sensor, a dedicated AI chip, cloud computing, distributed storage, a big data processing technology, an operating/interaction system, and electromechanical integration. AI software technologies may include several major directions such as a computer vision technology, a speech processing technology, a natural language processing technology, and machine learning (ML)/deep learning.

(2) ML: It is a multi-disciplinary interdiscipline, involving a plurality of disciplines such as the probability theory, statistics, approximation theory, convex analysis, and algorithm complexity theory. ML involves how a computer simulates or implements a human learning behavior to obtain new knowledge or skills, and reorganizes an existing knowledge structure to continuously improve its own performance. ML is the core of AI and a fundamental way to make computers intelligent, and is applied to various fields of AI. ML and deep learning may include technologies such as an artificial neural network, a belief network, reinforcement learning, transfer learning, inductive learning, and learning from demonstration.

(3) Convolutional neural network (CNN): It is a feedforward neural network that includes convolutional calculation and has a deep structure. The CNN has the ability of representation learning, and can perform translation-invariant classification on input information based on a hierarchical structure of the CNN.

(4) Generative adversarial network (GAN): The GAN is a deep learning model. The model generates output through mutual game learning of (at least) two modules in a framework, for example, a generator G(generative model) and a discriminator D (discriminative model). The generator and the discriminator compete with each other. A training goal of the generator is to generate a sample that is realistic enough, and the discriminator may not distinguish a generation result from a real sample. A training goal of the discriminator is to successfully distinguish between the real sample and synthesized data of the generator, and iteratively update parameters of G and D until the GAN meets a convergence condition.

(5) Image conversion (image-to-image translation): Similar to a fact that different languages may be used to describe the same thing, and the same scene may be represented by using different images such as an RGB image, a semantic label map, and an edge map, the image conversion refers to a process of converting a scene from one image representation to another image representation. In some embodiments, image conversion is performed on a face image or a video including a defect element, to obtain a face image or a video not including the defect element.

(6) High definition: It is referred to as HD for short, which represents an image or a video with a vertical resolution greater than or equal to 720, for example, 720p, also referred to as an HD image or an HD video with sizes of 1280*720 and 1920*1080, for example. Based on an aspect ratio of 16:9, 720p refers to a size of 1280*720, for example, a horizontal pixel and a vertical pixel.

(7) Full HD: It is referred to as FHD for short, which represents an image or a video with a vertical resolution greater than or equal to 1080, for example, 1080p. Based on an aspect ratio of 16:9, 1080p refers to a size of 1920*1080, for example, a horizontal pixel and a vertical pixel.

(8) Defect element: It refers to some skin elements included on a face image. The skin elements may be elements that affect a face as a result of a genetic factor, a chemical method, or another physical method, for example, elements such as a pimple, a spot, a scar, a wrinkle, and a mole.

With the research and progress of the AI technology, the AI technology has been studied and applied in a plurality of fields, for example, a smart home, a smart wearable device, a virtual assistant, a smart speaker, smart marketing, unmanned driving, automatic driving, an unmanned aerial vehicle, a robot, smart medical care, and smart customer service.

The solutions provided in some embodiments relate to technologies such as a neural network of AI, which are described by using the following embodiments.

During post-processing, retouching software may be used by a human to perform retouching based on manual experience. The retouching software may be for example Photoshop, which may have a large workload and a long processing period, resulting in excess labor costs and low image processing efficiency.

Another manner is using a deep learning algorithm to modify an advanced attribute of a character image. The advanced attribute may be for example identity, pose, gender, age, and presence/absence of glasses or beard, to obtain an image processing result. However, the solution is globally changing pixels of the entire image, resulting in a relatively rough and one-sided processed image that lacks characteristics such as a skin texture and a sense of quality of a real face. For example, when various defects such as the mole and the pimple exist in the face image, the mole and the pimple may be removed during portrait beautifying. Processing of the skin texture may be uneven or unnatural, causing the beautified portrait to be distorted and lack textures and qualities of the original skin. For post-processing of film and television works, only the pimple may be targeted for removal. Considering the mole as an attribute of a character, the mole may be retained. However, by use of such methods described above, such single effects may not adequately distinguish such differences.

Some embodiments provide an image processing method and apparatus, a device, a storage medium, and a program product. A face image to be processed may be obtained by recognizing a face region of an image to be processed, thereby providing guidance information for image conversion, so as to perform image conversion on the face image to be processed in a targeted manner, including using a model to convert an image including a defect into an image not including the defect.

In addition, a training sample of an image processing model uses a face image having a face distortion degree less than a preset threshold and annotated with a defect element (such as a pimple), and a corresponding label image uses a face image that includes another element in the training sample other than the image annotated with the defect (such as the pimple), and a trained image processing model may process an HD image (for example, a face image with a relatively small distortion degree, for example, video frames of an HD film or television play), to ensure that the face is not distorted when the model transforms the image. By virtue of the image processing model, the image conversion can be performed at a finer granularity, so as to obtain a target face image that does not include the defect element (such as the pimple) and that has characteristics such as a skin texture closer to those of a real face. During the post-processing of the film or television work, for example, when various defects such as the mole and the pimple appear in the face image, only the pimple can be removed, and another element (such as the mole) except the pimple can be retained. On the basis of retaining authenticity of the face image, accuracy of performing the image conversion on the face image to be processed may be improved.

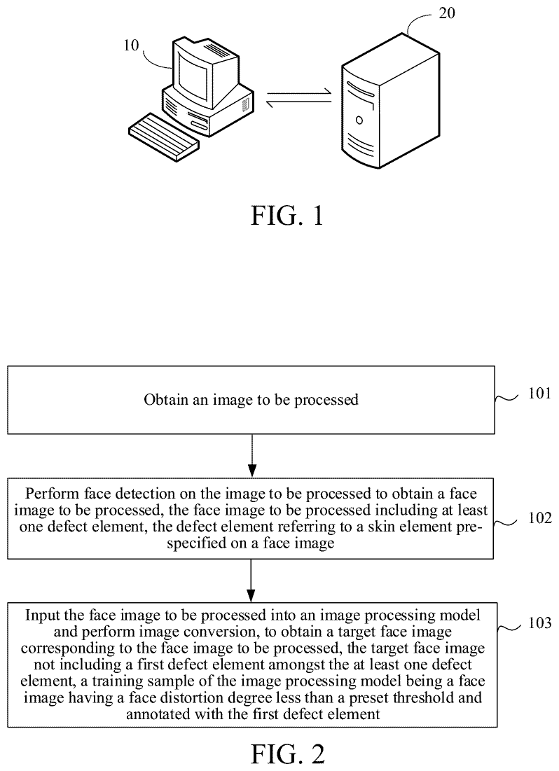

FIG. 1 is an architecture diagram of an implementation environment of an image processing method according to some embodiments. As shown in FIG. 1, the architecture of the implementation environment includes a terminal 10 and a server 20.

In the field of image processing, a process of performing image conversion on an image to be processed may be performed in the terminal 10 or in the server 20. For example, an image to be processed including a defect element is acquired through the terminal 10, and the image conversion may be performed locally in the terminal 10, to obtain a target face image corresponding to the image to be processed that does not include a defect element. The image to be processed including the defect element may be transmitted to the server 20, and the server 20 may obtain the image to be processed, may perform the image conversion based on the image to be processed, may obtain the target face image corresponding to the image to be processed that does not include the defect element, and may transmit the target face image to the terminal 10, to implement the image conversion on the image to be processed.

An image processing solution provided in some embodiments may be applied to scenarios such as post-processing of an image or video, graphic design, advertising photography, image creation, and web page production. In the foregoing application scenarios, an initial face image may be acquired, the image conversion may be performed on the initial face image to obtain the target face image of the initial face image, and an operation may be performed based on the target face image, such as the graphic design, the web page production, and video image editing.

In addition, an operating system may be run on the terminal 10. The operating system may include, but is not limited to, an Android system, an IOS system, a Linux system, Unix, and a Windows system, and may further include a user interface (UI) layer. Display of the image to be processed and display of the target face image of the image to be processed may be externally provided through the UI layer. In addition, the image to be processed may be transmitted to the server 20 based on an application programming interface (API).

In some embodiments, the terminal 10 may be a terminal device in various AI application scenarios. For example, the terminal 10 may be a notebook computer, a tablet computer, a desktop computer, an on-board terminal, a mobile device, and the like. The mobile device may be for example various types of terminals such as a smartphone, a portable music player, a personal digital assistant, a dedicated messaging device, and a portable gaming device, however, the disclosure is not limited thereto.

The server 20 may be a server, or may be a server cluster formed by a plurality of servers or a distributed system, and may further be a cloud server providing cloud computing services such as cloud service, a cloud database, cloud computing, a cloud function, cloud storage, a network service, cloud communication, a middleware service, a domain name service, a security service, a content delivery network (CDN), and a big data and AI platform.

A communication connection is established between the terminal 10 and the server 20 through a wired network or a wireless network. In some embodiments, the wireless network or the wired network described above uses a standard communication technology and/or protocol. The network is usually the Internet, but may also be any network, including but not limited to a local area network (LAN), a metropolitan area network (MAN), a wide area network (WAN), a mobile, wired, or wireless network, or any combination of a dedicated network or a virtual dedicated network.

For case of understanding and description, an image processing method and apparatus, a device, a storage medium, and a program product provided in some embodiments are described in detail below with reference to FIG. 2 to FIG. 18.

FIG. 2 is a schematic flowchart of an image processing method according to some embodiments. The method may be performed by a computer device. The computer device may be the server 20 or the terminal 10 in the system shown in FIG. 1 described above, or the computer device may be a combination of the terminal 10 and the server 20. As shown in FIG. 2, the method includes the following operations.

101: Obtain an image to be processed.

In this operation, the image to be processed refers to an image that is to be processed, may include a face image to be processed, and may further include a background image. The face image to be processed refers to a face image including a defect element in the image to be processed. The background image refers to an image in the image to be processed other than the face image to be processed, which may be for example a vehicle, a road, a pole, a building, the sky, the ground, a tree, or a face image that does not include the defect element.

In some embodiments, during the obtaining of the image to be processed, an image acquisition apparatus may be invoked to acquire an image to be processed. The image to be processed may be obtained through the cloud, and may further be obtained through a database or a blockchain. The image to be processed may further be imported and obtained from an external device.

In some embodiments, the foregoing image acquisition apparatus may be a video camera or a camera, or may be a radar device such as a laser radar or a millimeter-wave radar. The video camera may be a monocular video camera, a binocular video camera, a depth video camera, a three-dimensional video camera, and the like. In some embodiments, during the image obtaining through the video camera, the video camera may be controlled to enable a video recording mode, scan a target object in a field of view of the video camera in real time, and perform shooting at a specified frame rate to obtain a character video, and generate the image to be processed through processing.

In some embodiments, an image video regarding a character that is shot in advance may be obtained through the external device, the image video is preprocessed, for example, a blurred frame and repeated frames are removed from the image video, and cropping is performed, so as to obtain a key frame including a character to be processed, and obtain the image to be processed based on the key frame.

The foregoing image to be processed may be in the format of an image sequence, or may be in the format of a three-dimensional point cloud image, and may further be in the format of a video image.

102: Perform face detection on the image to be processed to obtain a face image to be processed, the face image to be processed including at least one defect element, the defect element referring to a skin element pre-specified on a face image.

In this operation, the defect element refers to the skin element pre-specified on the face image, for example, some skin elements included on the face image. The skin element may be an element that appears on a face affected by a genetic factor, a chemical method, or another physical method, for example, an element such as a pimple, a spot, a scar, a wrinkle, or a mole.

The foregoing face image to be processed may include one type of defect element, or may include a plurality of defect elements of the same type, and may further include a plurality of defect elements of different types.

The defect element may include information such as a defect size, a defect type, and a defect shape. The defect size is configured for representing size information of the defect element, the defect type is configured for representing type information of the defect element, and the defect shape is configured for representing shape information of the defect element.

The pimple as an example of the defect element, also referred to as acne, may include different acne types, which may be for example acne papulosa, pustular acne, cystic acne, nodular acne, acne conglobata, and acne keloidalis. The spot as an example of the defect element may include different spot types, which may be for example freckles, sunburn, and chloasma. The scar as an example of the defect element may include different scar types, for example, hyperplastic scars, pitted scars, flat renaturation scars, and keloid. The wrinkle as an example of the defect element may include different wrinkle types, which may be for example crow's feet, frown lines, forehead wrinkles, nasolabial folds, and neck lines.

After the image to be processed is obtained, a face detection rule may be used to perform the face detection on the image to be processed. Detection may be performed and locating may be performed. The detection refers to a determination as to whether a face region including the defect element exists in the image to be processed. The locating refers to a determination of a position of the face region including the defect element in the image to be processed. After the face is detected and a key feature point of the face is located, the face region including the defect element is determined, the face region is cropped, and the cropped image is preprocessed, to obtain the face image to be processed.

The foregoing face detection algorithm may be for example a detection algorithm based on a face feature point, a detection algorithm based on an entire face image, a template-based detection algorithm, and a detection algorithm using a neural network.

In some embodiments, the foregoing face detection rule refers to a face detection strategy preset in the image to be processed based on an application scenario, which may be a trained face detection model, may be a face detection algorithm, or the like.

In some embodiments, feature extraction may be performed on the image to be processed through a face detection model, to obtain the face image to be processed including the defect element.

The face detection model is a network structure model that learns the face feature extraction ability by training sample data. The face detection model is a neural network model having an input of the image to be processed and an output of the face image to be processed including the defect element, and having the ability to perform image detection on the image to be processed, for example, capable of predicting the face image to be processed including the defect element. The face detection model may include a multilayer network structure. The network structure at a different layer processes input data differently, and transmits an output result to a next network layer until the output result is processed through a last network layer, to obtain the face image to be processed including the defect element.

In some embodiments, the face image to be processed including the defect element in the image to be processed is detected through an image recognition algorithm. The image recognition algorithm may be, for example, scale-invariant feature transform (SIFT), speeded up robust feature (SURF), or oriented FAST and rotated BRIEF (ORB) for feature detection.

In some embodiments, an image feature of the image to be processed may further be compared with an image feature in a template image database by querying a pre-established template image database. An image having features that have a perfect match with those of the image to be processed and a template image in the template image database is determined as the face image to be processed including the defect element. The template image database may be flexibly configured based on the face image feature information in the application scenario, and face elements of features such as different face types, face shapes, and face structures including the defect element are summarized and arranged to construct the template image database.

In some embodiments, the face image to be processed can be accurately obtained by performing the face detection on the image to be processed, thereby providing more accurate data guidance information for image conversion, so as to perform the image conversion on the face image to be processed in a targeted manner.

103: Input the face image to be processed into an image processing model and perform image conversion, so as to obtain a target face image corresponding to the face image to be processed, the target face image not including a first defect element amongst the at least one defect element, a training sample of the image processing model being a face image having a face distortion degree less than a preset threshold and annotated with the first defect element.

In this operation, a label image corresponding to the training sample is a face image including another element in the training sample other than the first defect element.

The foregoing image processing model may be a model that performs the image conversion on the face image to be processed. The image processing model is a network structure model that learns the image conversion ability by training the sample data. The image processing model is a neural network model having an input of the face image to be processed including the defect element and an output of the target face image that does not include the first defect element, and having the ability to perform the image conversion on the face image to be processed, for example, capable of removing the defect element on the face image to be processed.

The image processing model has an optimal model parameter, for example, a parameter corresponding to a loss function having the smallest value during model training. The image processing model may include a multilayer network structure. The network structure at a different layer processes input data differently, and transmits an output result to a next network layer until the output result is processed through a last network layer, to obtain the target face image not including the first defect element. The foregoing target face image refers to a synthesized image output by the image processing model after performing the image conversion.

In some embodiments, the foregoing image processing model may be a cycle GAN model upon completion of training, or may be a deep convolutional GAN (DCGAN) upon completion of training, and may further be a GAN of another type such as a star GAN (StarGAN) upon completion of training.

The image processing model may include a convolutional network and a deconvolutional network. After the face image to be processed is obtained, the face image to be processed may be inputted into the convolutional network of the image processing model for convolution, to obtain a plurality of face features. The face features include defect features and non-defect features. The defect features may include features corresponding to the defect elements such as the mole, the pimple, the spot, and the wrinkle. The non-defect features include all features amongst the face features other than the defect features, for example, features corresponding to face elements such as a nose, a mouth, and eyebrows. The defect features are screened to remove a target defect feature corresponding to the first defect element amongst the defect features. For example, the first defect element is the pimple or the spot. The rest of the defect features and the non-defect features are used as background features, and deconvolution is performed on the background features through the deconvolutional network, to obtain the target face image corresponding to the face image to be processed. The target face image is a face image that does not include the first defect element.

Exemplarily, when the face image to be processed includes the defect elements such as the mole and the pimple, the face image to be processed may be inputted into the convolutional network of the image processing model for convolution, to obtain a plurality of face features. The plurality of face features may include defect features and non-defect features. The defect features may be the mole and the pimple that are relatively similar. The non-defect features may be the remaining features other than the mole and the pimple amongst the face features such as the nose, the mouth, and the eyebrows. The defect elements (such as the mole and the pimple) are screened to remove the target defect feature (such as the pimple), the remaining defect features (such as the mole) and all non-defect features are used as background features, and the background features are restored through the deconvolutional network, to obtain a target face image in which only the target defect feature (such as the pimple) is removed and the remaining defect feature (such as the mole) and the remaining features (such as the face features such as the nose, the mouth, and the eyebrows) except the defect features are retained.

The foregoing target face image corresponding to the face image to be processed refers to a face image having attributes such as identity, ray of light, pose, background, and expression the same as those of the face image to be processed, regardless of whether a defect element is present in the face image.

The training sample of the foregoing image processing model is the face image having the face distortion degree less than a preset threshold and annotated with the first defect element, and the face distortion degree refers to a corresponding value during distortion of the training sample, to ensure that the face image has a small distortion, which indicates a small distortion degree relative to a real face.

The face distortion degree being less than the preset threshold may be understood as a similarity between the training sample and the real face being greater than the preset threshold. The preset threshold may be customized based on experimentation. The similarity between the training sample and the real face may be determined based on a face attribute parameter of the face image and a face attribute parameter of the real face.

A face attribute is configured for representing feature description information of the face, which may include, for example, attributes such as a face skin texture, a face skin color, a face brightness, a face wrinkle texture, and a face defect element. The defect element attribute may include a size of the defect element, a shape of the defect element, a type of the defect element, and the like.

In some embodiments, the similarity between the training sample and the real face may be calculated by using a Euclidean distance based on attributes such as the face skin texture, the face skin color, the face brightness, the face wrinkle texture, and the face defect element of the training sample and the real face, or the similarity between the training sample and the real face may be calculated by using a Pearson correlation coefficient, and the similarity between the training sample and the real face may further be calculated by using a cosine similarity.

Exemplarily, the foregoing training sample may be obtained by selecting a key frame corresponding to a face image from a historical film or television work that does not include the first defect element and has the face distortion degree meeting a preset condition, and adding a defect sample element to the key frame for processing. The film or television work may be for example one or several episodes of a film or a television series.

In some embodiments, the face image having the face distortion degree less than the preset threshold and annotated with the first defect element may be obtained in advance, and is used as the training sample, and a face image including another element in the training sample other than the first defect element is obtained and used as the label image corresponding to the training sample. The image processing model is obtained through training by the training sample and the label image.

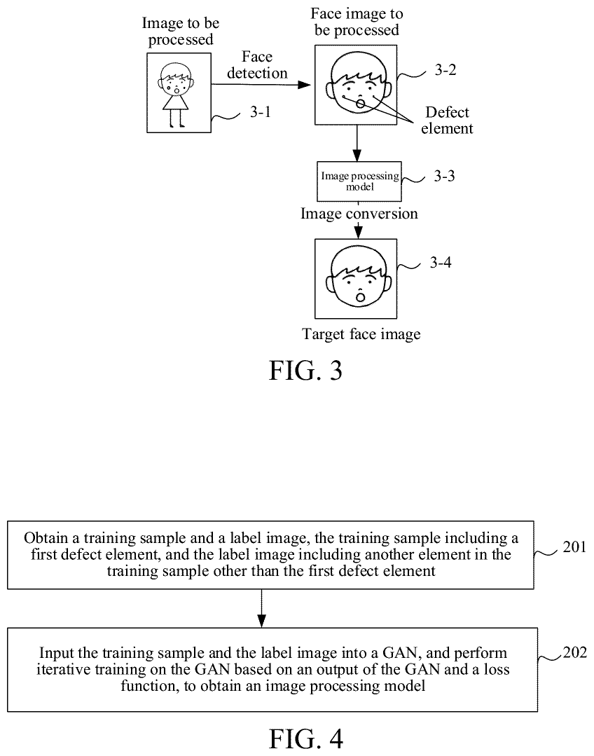

Then as shown in FIG. 3, an image 3-1 to be processed is obtained. Face detection is performed on the image 3-1 to be processed, to obtain a face image 3-2 to be processed including a defect element. The face image 3-2 to be processed is inputted into an image processing model 3-3 and image conversion is performed, so as to obtain a target face image 3-4 corresponding to the face image to be processed, for example, a face image that does not include a first defect element.

When a training sample used during training of an image processing model is a face image including a pimple, and a corresponding label image is a face image including another element in the training sample other than the pimple, the obtained target face image is an image in which only the pimple is removed and another element in the face image to be processed other than the pimple is retained after image conversion is performed on the face image to be processed through the image processing model during model application.

Similarly, when a training sample used during training of an image processing model is a face image including a mole, and a corresponding label image is a face image including another element in the training sample other than the mole, the obtained target face image is an image in which only the mole is removed and another element in the face image to be processed other than the mole is retained after the image conversion is performed on the face image to be processed through the image processing model.

Some embodiments provide an image processing method. The face image to be processed may be obtained by detecting the face region of the image to be processed, thereby providing guidance information for image conversion, so as to perform the image conversion on the face image to be processed in a targeted manner. In addition, the training sample of the image processing model uses the face image having a face distortion degree less than the preset threshold and annotated with the first defect element, and the trained image processing model may process the face image to be processed having the face distortion degree less than the preset threshold and including the defect element. The image conversion may be performed at a finer granularity, so as to obtain the target face image that does not include the defect element and that has characteristics such as a skin texture closer to those of a real face, thereby improving accuracy of performing the image conversion on the face image to be processed.

In some embodiments, before the face image to be processed is inputted into the image processing model and the image conversion is performed, the image processing model may be trained. Some embodiments further provide a training process for training the image processing model. As shown in FIG. 4, the following operations may be included.

201: Obtain a training sample and a label image, the training sample including a first defect element, and the label image including another element in the training sample other than the first defect element.

The training sample and the label image described above are samples configured to train the image processing model. The training sample is a face image including the first defect element, which may further include another element other than the first defect element. The label image corresponding to the training sample includes another element other than the first defect element, for example, a vehicle, a road, a pole, a building, the sky, the ground, a tree, or another part of a human body.

In some embodiments, the foregoing label image may be acquired and transmitted in advance through an image acquisition apparatus, or may be obtained through a database or a blockchain, and may further be imported and obtained from an external device. An HD image video or a full HD image video may be acquired in advance through the image acquisition apparatus, and a key frame of the image video is extracted to obtain the key frame. The key frame may be for example a face image that does not include the first defect element and has a face distortion degree meeting a preset condition. The face image may have a less distortion degree than a real face. The foregoing label image may also be a manually screened or pre-specified face image that does not include the first defect element, or may be a face image that is automatically obtained by using a method such as ML and does not include the first defect element.

The training sample corresponding to the label image may be obtained after performing preprocessing operations such as obtaining a face feature point, performing cropping and alignment, and adding a first non-defect element on the label image.

202: Input the training sample and the label image into a GAN, and perform iterative training on the GAN based on an output of the GAN and a loss function, to obtain the image processing model.

The removal of the defect element may involve only local skin of the face, and may use filling with normal skin to implement a natural transition with surrounding skin during the removal of the defect element on the face image. The task may be regarded as an image conversion problem, and a GAN model may be used to obtain the image conversion model through training, for example, Pixel2Pixel and Pix2PixHD.

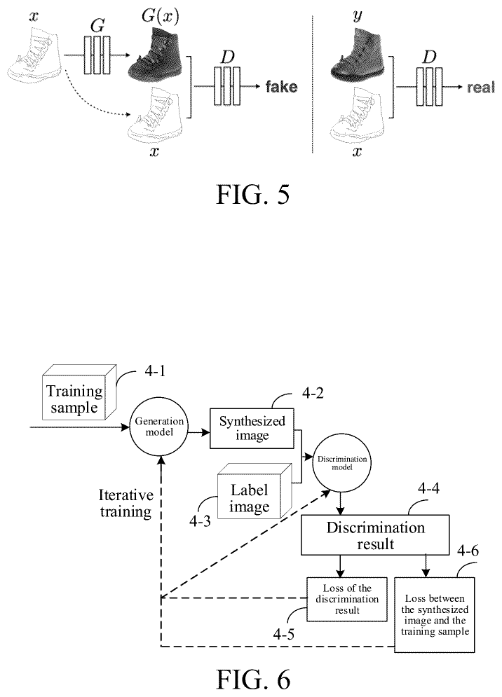

FIG. 5 shows a process of an image conversion method by using conversion from a freehand sketch of a shoe to a real image as an example. The GAN includes a generator G and a discriminator D. A freehand sketch x is inputted into the generator G, to obtain a synthesized image G(x), authenticity of the synthesized image G(x) and a real image y is determined through the discriminator D, and a model is trained by constructing a loss function. For example, it is determined through the discriminator D based on the freehand sketch x that the synthesized image G(x) is fake; and it is determined through the discriminator D based on the freehand sketch x that the real image y is real.

Pix2PixHD respectively improves the generator, the discriminator, and the loss function based on Pixel2Pixel, thereby implementing image conversion at a high resolution.

The GAN proposed in some embodiments improves the loss function based on a Pix2PixHD network framework. In addition to a loss between the synthesized image and the training sample, a loss of a discrimination result is further increased. The loss of the discrimination result may be a loss generated during matching of features of the label image and the synthesized image at different intermediate layers of a discrimination model, thereby implementing an image conversion effect.

The foregoing GAN is a neural network model having an input of the training sample and the label image and an output of the discrimination result and having the ability to perform image conversion, perform discrimination on the training sample, for example, capable of performing the image conversion. The GAN may be an initial model during iterative training, for example, a model parameter of the GAN is in an initial state, or may be a model adjusted in a previous round of iterative training, for example, the model parameter of the GAN is in an intermediate state.

The foregoing GAN may include a generation model and a discrimination model. The generation model, for example, a generation model, is configured to perform image conversion on the training sample including a first defect element to form a synthesized image. The discrimination model, for example, a discrimination model, is configured to discriminate between the synthesized image and the label image, to obtain a corresponding discrimination result.

One or more discrimination models are provided. A larger quantity of discrimination models indicates a higher accuracy of image conversion performed by a trained image processing model. When a plurality of discrimination models are provided, an image inputted by each discrimination model has a different feature. For example, the inputted images have different resolutions. Each discrimination model is independent of each other.

As shown in FIG. 6, during the iterative training performed on the GAN, a training sample 4-1 may be inputted into the generation model and image conversion is performed to obtain a synthesized image 4-2. The synthesized image 4-2 and a label image 4-3 are inputted into a discrimination model, and a discrimination result 4-4 is obtained. The discrimination result is configured for representing a probability that the synthesized image is the same as the label image. A loss function is constructed based on a loss 4-6 between the synthesized image and the training sample and a loss 4-5 of the discrimination result (for example, a loss between the synthesized image and the label image). The iterative training is performed on the generation model and the discrimination model based on the loss function, and an image processing model is determined based on a trained generation model.

The discrimination result may include the probability that the synthesized image is the same as the label image, which may be understood as a probability that the synthesized image matches, is highly similar to, or is a highly restored version of the label image. The foregoing discrimination result may include a first sub-discrimination result regarding the synthesized image obtained by the discrimination model based on comparison of the synthesized image and the training sample, and a second sub-discrimination result regarding the label image obtained by the discrimination model based on comparison of the label image and the training sample.

When three discrimination models are provided, the loss of performing the iterative training on the generation model and the discrimination model may include the loss between the synthesized image and the training sample and the loss of the discrimination result, which is expressed by using the following equation:

$${min}_{G} ( ( {max}_{D 1 , D 2 , D 3} {\sum }_{k = 1 , 2 , 3} {L}_{GAN} ( G , {D}_{K} ) ) + λ {\sum }_{k = 1 , 2 , 3} {L}_{FM} ( G , {D}_{K} ) ) \qquad ( 1 )$$

where Σ_{k=1,2,3}·L_{GAN}(G, D_{K}) is the loss between the synthesized image and the training sample, Σ_{k=1,2,3}L_{FM}(G, Dₖ) is the loss of the discrimination result, G is a generation model, Dₖ is a k^{th} discrimination model, D₁, D₂, and D₃ are respectively a first discrimination model, a second discrimination model, and a third discrimination model, and A is a loss weight corresponding to the loss of the discrimination result.

The foregoing loss between the synthesized image and the training sample may be expressed by using the following equation:

$${L}_{GAN} ( G , {D}_{K} ) = {E}_{( s , x )} [ log {D}_{k} ( s , x ) ] + {E}_{s} [ log ( 1 - {D}_{k} ( s , G ( s ) ) ) ] \qquad ( 2 )$$

where s is the training sample, x is the label image, Dₖ is the k^{th} discrimination model, E_{(s,x)} is a mean value of the training sample and the label image, Eₛ is a mean value of the training samples, and G(s) is the synthesized image output by the generation model.

The loss of the foregoing discrimination result may be determined by using the following equation:

$${L}_{F M} ( G , {D}_{k} ) = {E}_{( s , x )} {\sum }_{i = 1}^{T} \frac{1}{{N}_{i}} [ \vert \vert {D}_{k}^{( i )} ( s , x ) - {D}_{k}^{( i )} ( s , G ( s ) ) \vert \vert 1 ] \qquad ( 3 )$$

where s is the training sample, x is the label image, G is the generation model, Dₖ is the k^{th} discrimination model, E_{(s,x)} is a mean value of the training sample and the label image, G(s) is the synthesized image output by the generation model, T is a quantity of discrimination layers of the k^{th} discrimination model Dₖ, and Nᵢ is a quantity of elements corresponding to an i^{th} discrimination layer in the k^{th} discrimination model Dₖ.

The generation model is configured to perform the image conversion on the training sample, and use the image with the first defect element being removed as the synthesized image. However, the discrimination model is configured to receive the synthesized image, and determine whether a pair of images (including the synthesized image and the label image corresponding to the training sample) are real or fake. In addition, a training objective of the discrimination model is to determine that the label image is real and the synthesized image is fake. However, a training objective of the generation model is to perform the image conversion on an inputted training sample to obtain a synthesized image for which the discrimination model has a discrimination result of real, for example, to cause a generated image to be similar to a label image, to achieve an effect of deceiving.

In some embodiments, the foregoing generation model may be a CNN or a residual neural network based on deep learning.

In some embodiments, the CNN may include a convolutional network and a deconvolutional network. A training sample is inputted into the convolutional network and feature extraction is performed, to obtain a plurality of face features. The face features include defect features and non-defect features. The defect features are screened, target defect features are removed from the defect features, the remaining defect features and the non-defect features are used as background features, and the background features are restored through the deconvolutional network to obtain a synthesized image corresponding to the training sample.

In some embodiments, the residual neural network may include the convolutional network, a residual network, and the deconvolutional network that are cascaded in sequence. The residual network may include a series of residual blocks. Each residual block includes a direct mapping part and a residual part. The residual part may include two or more convolution operations.

Exemplarily, the training sample may be inputted into the generation model and the image conversion is performed, and feature extraction is performed successively through the convolutional network to obtain sample features. To avoid problems of gradient disappearing and model overfitting, the sample features are processed through the residual network to obtain a processing result, and the processing result is restored through the deconvolutional layer to obtain the synthesized image. The synthesized image may be mapped back to a pixel space of the inputted training sample.

The foregoing convolutional network may include a convolutional module, a rectified linear unit (ReLU) operation module, and a pooling operation module. Modules included in the deconvolutional network may in one-to-one correspondence with the modules included in the convolutional network, and may include an unpooling operation module, a correction module, and a deconvolution operation module. The unpooling operation module corresponds to the pooling operation module of the convolutional network. The correction module corresponds to the ReLU operation module in the convolutional network. The deconvolution operation module corresponds to the convolution operation module of the convolutional network.

In some embodiments, the foregoing generation model includes a convolutional layer, a pooling layer, a pixel supplement layer, a deconvolutional layer, and a pixel normalization layer. The feature of the training sample is extracted through the convolutional layer to obtain image features. Dimension reduction is performed on the extracted image features through the pooling layer, to obtain features after the dimension reduction. Pixel filling is performed through the pixel supplement layer to obtain a feature map, the feature map is restored through the deconvolutional layer, and results obtained after the restoration operation are normalized through the pixel normalization layer, so as to obtain a synthesized image.

In a neural network architecture, deep features of the image are first extracted through the convolution operation and the pooling operation during downsampling. However, compared with the inputted image, a plurality of convolution operations and pooling operations cause the obtained feature map to continuously decrease, resulting in an information loss. Therefore, in some embodiments, to reduce the information loss, for each downsampling, corresponding upsampling is performed to restore a size of the inputted image, and an upsampling parameter and a downsampling parameter may be equal. The image may be zoomed out at an upsampling stage, and the image is may be zoomed in at a downsampling stage. In some embodiments, the generation model uses a Unet network structure having a symmetric size. The generation model further uses a tanh function as an activation function during the upsampling.

In some embodiments, feature maps of different sizes may be obtained through the Unet network structure by using the generation model of the Unet network structure, so as to enhance the expression ability of the feature map. In some embodiments, the image processing model may extract the feature map having stronger expression ability by relying on the Unet network structure, to reduce a loss of original information during the convolution of the generation model and cause the generation model to accurately extract the face feature in the training sample, thereby improving quality of the image output by the generation model.

In some embodiments, the foregoing discrimination model is a neural network model having an input of the synthesized image and the label image and an output of the discrimination result of the synthesized image and the label image, and having the ability to discriminate the synthesized image and the label image, for example, capable of predicting the discrimination result. The discrimination model is responsible for establishing a relationship among the synthesized image, the label image, and the discrimination result, and a model parameter thereof is already in an initial training or iterative training state.

In some embodiments, the foregoing discrimination model may be a direct cascade classifier, a CNN, a support vector machine (SVM), or a Bayes classifier.

In some embodiments, the discrimination model may include, but is not limited to, a convolutional layer, a fully connected layer, and an activation function. The convolutional layer and the fully connected layer may include one layer, or may include a plurality of layers. The convolutional layer is configured to perform feature extraction on the synthesized images, and the fully connected layer may be configured to classify the synthesized images. The synthesized image may be processed through the convolutional layer to obtain convolution features. The convolution features are processed through the fully connected layer to obtain a fully connected vector, and the fully connected vector is processed through the activation function to obtain an output result of the synthesized image and the label image. The output result includes a probability that the synthesized image is the same as the label image.

The foregoing activation function may be a sigmoid function, or may be a tanh function, and may further be an ReLU function. The fully connected vector is processed through the activation function, and the result thereof can may be mapped to be between 0 and 1.

When a plurality of discrimination models are provided, the synthesized image and the label image may be respectively inputted into the plurality of discrimination models, to obtain a discrimination result corresponding to each discrimination model. The discrimination result is configured for representing the probability that the synthesized image is the same as the label image.

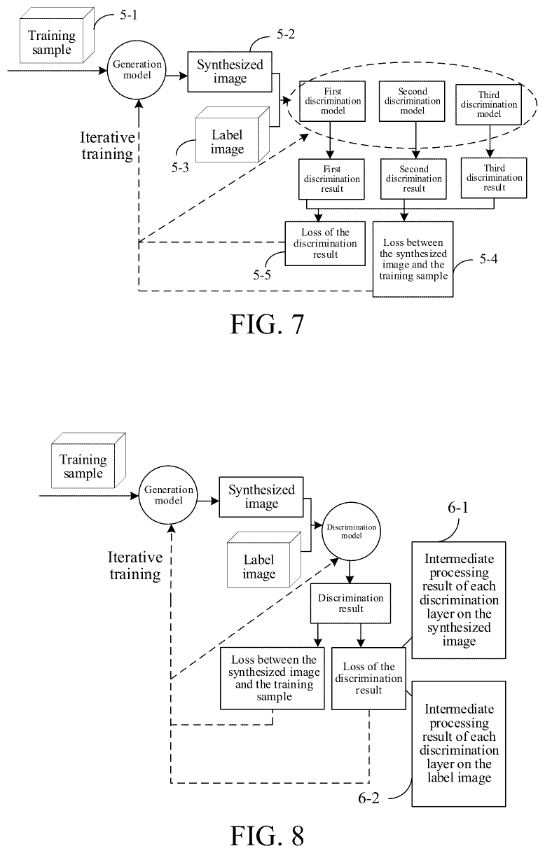

As shown in FIG. 7, when three discrimination models are respectively a first discrimination model, a second discrimination model, and a third discrimination model, a training sample 5-1 is inputted into a generation model and image conversion is performed to obtain a synthesized image 5-2, and the synthesized image 5-2 and a label image 5-3 may be inputted into the first discrimination model, to obtain a first discrimination result. Downsampling is performed on the synthesized image to obtain a first reconstructed image, and the first reconstructed image and the label image are inputted into the second discrimination model, to obtain a second discrimination result. Downsampling is performed on the first reconstructed image again to obtain a second reconstructed image, and the second reconstructed image and the label image are inputted into the third discrimination model, to obtain a third discrimination result. A size of the synthesized image is greater than a size of the first reconstructed image, and the size of the first reconstructed image is greater than a size of the second reconstructed image. A loss 5-4 and a loss 5-5 between the synthesized image and the training sample are determined based on the first discrimination result, the second discrimination result, and the third discrimination result. A loss function is constructed based on the losses, and the generation model and the three discrimination models are trained to obtain an image processing model.

The foregoing first reconstructed image may be obtained through the following operations. For example, for a synthesized image having a size of M*N, an image in an s*s window of the synthesized image is changed into one pixel having a value that is a mean value of all pixels in the s*s window, and downsampling by a factor of s is performed to obtain a resolution of (M/s)*(N/s), which is s times smaller than that of the synthesized image, so as to obtain the first reconstructed image. Similarly, the second reconstructed image may also be obtained by using the foregoing method of zooming out the first reconstructed image by s times.

In addition, during iterative training of a generative adversarial model, a parameter of the generation model may remain unchanged, and iterative optimization training is performed on a parameter of the discrimination model by using an optimization method. The parameter of the discrimination model may remain unchanged, and the iterative optimization training is performed on a parameter of the generation model by using the optimization method. The iterative optimization training may further be performed together on the parameters of the generation model and the discrimination model by using the optimization method.

The foregoing optimization method may include a method for optimizing the loss function such as a gradient descent method, a Newton's method, and a quasi-Newton method. No limitation is imposed on the optimization method used for performing iterative optimization.

A negative direction of a current position is used as a search direction in the gradient descent method, because the direction is a direction of steepest descent of the current position. In the method of steepest decent, as a target value is approached, a step size decreases, and a speed of advance decreases. When the loss function is a convex function, a solution of the gradient descent method is a global solution.

The Newton's method is a method for approximately solving an equation in fields of real numbers and complex numbers. According to the method, first few terms of a Taylor series of a function f(x) are used to find a root of an equation f(x)=0.

The pseudo-Newton method is to improve a defect of the Newton's method that a complex inverse matrix of Hessian may be solved each time, which uses a positive definite matrix to approximate an inverse of a Hessian matrix, thereby reducing complexity of the operation.

In some embodiments, after the training sample is obtained, the training sample may be inputted into the generation model, and image conversion is performed successively through the convolutional network and the deconvolutional network, to obtain the synthesized image. The synthesized image and the label image are inputted into the discrimination model. Feature extraction is performed through the convolutional layer in the discrimination model to obtain sample features. The sample features are normalized based on a normal distribution through the normalization layer in the discrimination model, to filter noise features in the sample features and obtain a normalized feature. The normalized feature is inputted into the fully connected layer in the discrimination model to obtain a sample fully connected vector, and the sample fully connected vector is processed by using the activation function, to obtain a corresponding discrimination result. The iterative training is performed on the generation model and the discrimination model based on the loss between the synthesized image and the training sample and the loss of the discrimination result, and the image processing model is determined based on the trained generation model.

In some embodiments, that the iterative training is performed on the generation model and the discrimination model may mean updating parameters of the generation model and the discrimination model to be constructed, or updating parameters of matrices such as a weight matrix and a bias matrix in each of the generation model and the discrimination model to be constructed. The parameters of the weight matrix and the bias matrix include, but are not limited to, matrix parameters in the convolutional layers, the normalization layers, the deconvolutional layers, feedforward network layers, and the fully connected layers in the generation model and the discrimination model to be constructed.

During the iterative training performed on the generation model and the discrimination model based on the loss between the synthesized image and the training sample and the loss of the discrimination result, when it is determined based on the loss function that the generation model and the discrimination model to be constructed have not converged, the parameters of the model are adjusted, and the generation model and the discrimination model to be constructed may converge, thereby obtaining the generation model and the discrimination model. That the generation model and the discrimination model to be constructed converge may mean that a difference between output results of the generation model and the discrimination model to be constructed for the synthesized image and the label image is less than a preset threshold, or a change rate of the difference between the output results and the label image is close to a relatively small value. When a calculated loss function is relatively small, or a difference between the calculated loss function and a loss function output in a previous round of iteration is close to 0, it is considered that the generation model and the discrimination model to be constructed converge.

In some embodiments, the image processing model can be accurately obtained by training the GAN, the image conversion can be performed on a face image including a defect element through the image processing model, and correction and beautification can be performed by eliminating a corresponding defect element in the image, thereby improving image processing efficiency.

In some embodiments, during the iterative training performed on the generation model and the discrimination model based on the loss between the synthesized image and the training sample and the loss of the discrimination result, the loss of the discrimination result may be determined first. Some embodiments provide an implementation of determining the loss of the discrimination result.

The loss of the discrimination result may be a loss generated during matching of features of the label image and the synthesized image at different intermediate layers of a discrimination model.

In some embodiments, the training sample may be inputted into the generation model and image conversion is performed to obtain the synthesized image, and the synthesized image and the label image are inputted into the discrimination model to obtain a discrimination result. The loss of the discrimination result is determined based on the discrimination result.

In some embodiments, a mask image corresponding to the training sample may be generated based on a position annotated with a first defect element in the training sample. The mask image is configured to represent the position of the first defect element in the training sample. A defect region of each of the synthesized image and the label image is annotated based on the mask image, the synthesized image and the label image are updated, and a loss between the synthesized image and the label image is determined.

Removal of the defect element involves only a limited region of a face. A small difference between an inputted image and an output image may exist. To improve a processing effect of removing the defect element by the image processing model, the defect region of each of the synthesized image and the label image may be annotated during the determination of the loss of the discrimination result, so as to add a feature of the region annotated with the first defect element to the synthesized image and the label image.

The position of the first defect element may be annotated in the training sample to generate the mask image corresponding to the training sample. The mask image may be represented by a feature vector or a matrix. For a region annotated with the first defect element in the training sample, a corresponding position value in the matrix is 1. For a region not annotated with the first defect element in the training sample, a corresponding position value in the matrix is 0. The defect regions of the synthesized image and the label image are respectively annotated based on the mask image. A multiplication operation may be performed on a mask matrix corresponding to the mask image and a pixel matrix corresponding to the synthesized image, and the multiplication operation is performed on the mask matrix corresponding to the mask image and the pixel matrix corresponding to the label image, thereby updating the synthesized image and the label image and determining the loss of the discrimination result based on the loss between the synthesized image and the label image.

The foregoing discrimination model further includes at least one discrimination layer. As shown in FIG. 8, the loss of the discrimination result includes the loss between the synthesized image and the label image, and includes a loss between a first intermediate processing result and a second intermediate processing result output by each discrimination layer. The first intermediate processing result is an intermediate processing result 6-1 of each discrimination layer on the synthesized image, and the second intermediate processing result is an intermediate processing result 6-2 of each discrimination layer on the label image.

The foregoing discrimination layers may be for example discrimination layers such as a convolutional layer, a normalization layer, and a fully connected layer. The synthesized image may be processed successively through the discrimination layers such as the convolutional layer, the normalization layer, and the fully connected layer, to obtain the first intermediate processing result corresponding to each discrimination layer, and the label image is processed successively through the discrimination layers such as the convolutional layer, the normalization layer, and the fully connected layer, to obtain the second intermediate processing result corresponding to each discrimination layer.

Exemplarily, when the GAN includes a generation model and a discrimination model, and a plurality of discrimination models are provided, the loss of the discrimination result may be expressed by using the following equation:

$${L}_{F M - M a s k} ( G , {D}_{k} ) \qquad ( 4 )$$

$$= {E}_{( s , x )} {\sum }_{i = 1}^{T} \frac{1}{{N}_{i}} ( α [ \vert \vert {D}_{k}^{( i )} ( s * M , x * M ) - {D}_{k}^{( i )} ( s * M , G ( s ) * M ) {\vert \vert}_{1} ] + ( 1 -$$

$$α ) [ \vert \vert {D}_{k}^{( i )} ( s * ( 1 - M ) , x * ( 1 - M ) )$$

$$- {D}_{k}^{( i )} ( s * ( 1 - M ) , G ( s ) * ( 1 - M ) ) {\vert \vert}_{1} ] )$$

where s is the training sample, x is the label sample, G is the generation model, Dₖ is a k^{th} discrimination model, α is a loss weight corresponding to a region annotated with a first defect element, 1−α is a loss weight corresponding to another region except the region annotated with the first defect element, G(s) is a synthesized image output by the generation model, s*M is a region annotated with the first defect element in the mask image, s*(1−M) is another region in the mask image other than the region annotated with the first defect element, E_{(s,x)} is a mean value of the training sample and the label image, T is a quantity of discrimination layers of the k^{th} discrimination model Dₖ, Nᵢ is a quantity of elements corresponding to an i^{th} discrimination layer in the k^{th} discrimination model Dₖ, x*M is a region annotated with the first defect element in the label image, x*(1−M) is another region in the label image other than the region annotated with the first defect element, G(s)*M is a region annotated with the first defect element in the synthesized image, and G(s)*(1−M) is another region in the synthesized image other than the region annotated with the first defect element.

In some embodiments, the training loss of the foregoing GAN further includes a loss between the training sample and the label image corresponding to the training sample. During construction of the loss function, the following operation is further performed: determining the loss between the training sample and the label image.

To improve accuracy of training the GAN, the loss between the training sample and the label image corresponding to the training sample may be determined during the iterative training performed on the generation model and the discrimination model. The loss is used as a reconstruction loss to further improve accuracy of the trained generation model and the trained discrimination model, so as to obtain a relatively accurate image processing model.

The training sample may be inputted into the generation model and image conversion is performed to obtain a synthesized image, the synthesized image and the label image are inputted into the discrimination model to obtain a discrimination result, and the loss between the training sample and the label image corresponding to the training sample is determined based on the discrimination result.

The loss between the training sample and the label image corresponding to the training sample may be determined based on the following relations:

$$α , ( 1 - α ) , x * M , x * ( 1 - M ) , G ( s ) * M , G ( s ) * ( 1 - M )$$

where s is the training sample, a is a loss weight corresponding to a region annotated with a first defect element, 1−α is a loss weight corresponding to another region except the region annotated with the first defect element, x*M is a region annotated with a first defect element in the label image, x*(1−M) is another region in the label image other than the region annotated with the first defect element, G(s)*M is a region annotated with the first defect element in the synthesized image, and G(s)*(1−M) is another region of the synthesized image other than the region annotated with the first defect element.

In some embodiments, any operation such as addition and multiplication may be performed on the foregoing relations, to obtain the loss between the training sample and the label image corresponding to the training sample.

In some embodiments, the mask image corresponding to the training sample may be generated based on the position annotated with the first defect element in the training sample, the defect regions of the synthesized image and the label image are respectively annotated based on the mask image, and the synthesized image and the label image are updated to determine the loss between the training sample and the label image corresponding to the training sample.

Exemplarily, the loss between the training sample and the label image corresponding to the training sample may be determined by using the following equation:

$${L}_{R e c - M a s k} ( G ) = \qquad ( 5 )$$

$${E}_{( s , x )} ( α [ \vert \vert x * M - G ( s ) * M {\vert \vert}_{1} ] + ( 1 - α ) [ \vert \vert x * ( 1 - M ) -$$

$$G ( s ) * ( 1 - M ) \vert {\vert}_{1} ] )$$

where s is the training sample, x is the label sample, G is the generation model, E_{(s,x)} is a mean value of the training sample and the label image, α is the loss weight corresponding to the region annotated with the first defect element, 1−α is the loss weight corresponding to another region except the region annotated with the first defect element, G(s) is the synthesized image output by the generation model, x*M is the region annotated with the first defect element in the label image, x*(1−M) is another region in the label image other than the region annotated with the first defect element, G(s)*M is the region annotated with the first defect element in the synthesized image, and G(s)*(1−M) is another region in the synthesized image other than the region annotated with the first defect element.

During model training, a reasonable loss weight may further be assigned to each loss, and the synthesized image may be matched with a label image, thereby improving model performance.

In some embodiments, the loss between the synthesized image and the training sample may be used as a first component, the loss of the discrimination result is used as a second component, and the loss between the training sample and the label image corresponding to the training sample is used as a third component.

During determination of the loss function, the loss function may be determined based on the loss weights of the first component, the second component, and the third component, the first component, the second component, and the third component by determining loss weights of the first component, the second component, and the third component.

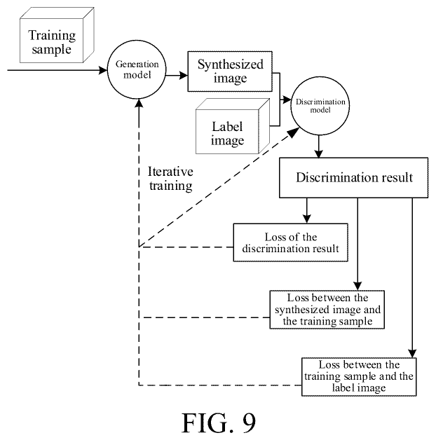

As shown in FIG. 9, the loss function may include the foregoing three losses, for example, the loss of the discrimination result, the loss between the synthesized image and the training sample, and the loss between the label image and the training sample.

In some embodiments, when the GAN includes one generation model and three discrimination models, the training sample is inputted into the generation model and image conversion is performed to obtain a synthesized image, and the synthesized image and the label image are respectively inputted into each discrimination model to obtain a corresponding discrimination result. The loss between the synthesized image and the training sample, the loss of the discrimination result, and the loss between the training sample and the label image are determined based on the discrimination result. The loss weights corresponding to the losses are determined, and the loss function is obtained by adding up the three losses based on the loss weight. The loss function may be obtained by using the following equation:

$${min}_{G} ( ( {max}_{D 1 , D 2 , D 3} {\sum }_{k = 1 , 2 , 3} {L}_{GAN} ( G , {D}_{k} ) ) + λ {\sum }_{k = 1 , 2 , 3} {L}_{FM - Mask} ( G , {D}_{K} ) + {μL}_{Rec - Mask} ( G ) ) \qquad ( 6 )$$

where G is the generation model, Dₖ is a k^{th} discrimination model, D₁, D₂, and D₃ are respectively a first discrimination model, a second discrimination model, and a third discrimination model, λ is a loss weight corresponding to the loss of the discrimination result, L_{GAN} (G, D_{K}) is the loss between the synthesized image and the training sample, L_{Rec-Mask} (G) is the loss between the training sample and the label image, L_{FM-Mask}(G, Dₖ) is the loss of the discrimination result, and u is a loss weight corresponding to the loss between the training sample and the label image.

Then the iterative training is performed on the generation model and the discrimination model based on minimization of the loss function, and an image processing model is determined based on a trained generation model.

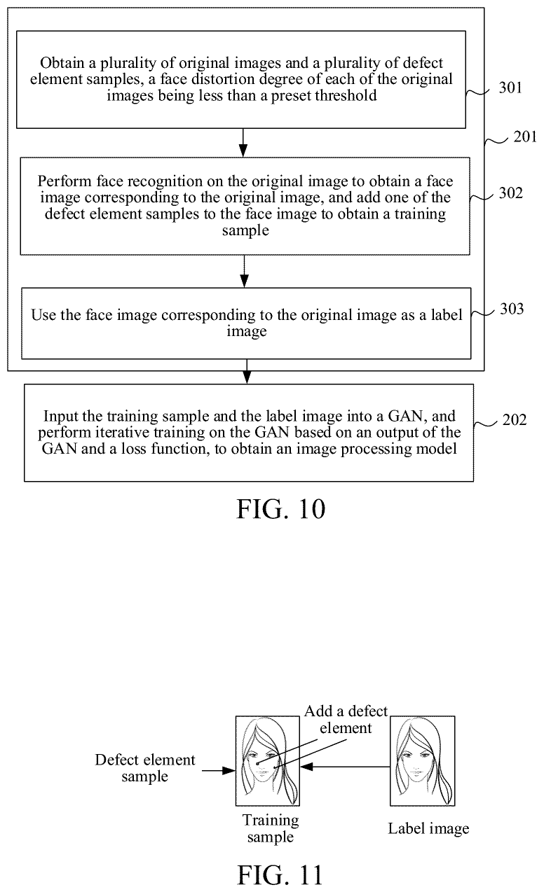

In some embodiments, before the training sample is inputted into the GAN, the training sample may be obtained. As shown in FIG. 10, some embodiments may include the following operations.

301: Obtain a plurality of original images and a plurality of defect element samples, a face distortion degree of each of the original images being less than a preset threshold.

That the face distortion degree of each original image is less than the preset threshold may mean that a face image has a small distortion, which indicates a small distortion degree relative to a real face. It may mean that a similarity between the original image and the real face exceeds a preset similarity threshold. The foregoing defect element samples refer to some skin element samples, which may be for example element samples such as a pimple, a spot, a scar, and a wrinkle. The defect element samples may include a plurality of defect element samples of different types, different attributes, different shapes, and different sizes.

The original image and the defect element sample may be obtained in advance through an image acquisition apparatus, or may be obtained through the cloud, may further be obtained through a database or a blockchain, and may further be imported and obtained through an external device.

The foregoing original image may be obtained by processing a video that does not include the defect element. For example, an original video may be obtained, a video frame that does not include the defect element is recognized, and the video frame is processed to obtain the original image.

The foregoing plurality of defect element samples may be obtained by processing the image that includes the defect element. For example, a historical face image including the defect element may be obtained, a defect element on the historical face image is recognized, and a region including the defect element is intercepted, to obtain the plurality of defect element samples.

302: Perform face detection on the original image to obtain a face image corresponding to the original image, and add one of the defect element samples to the face image to obtain a training sample.

303: Use the face image corresponding to the original image as a label image.

After the original image is obtained, face recognition and key point detection may be performed on a sample video corresponding to the original image based on a preset face resolution, to determine a reference video frame conforming to the face resolution and a corresponding face key point. A blurred video frame in the reference video frame is filtered to obtain a target video frame, and the target video frame is cropped based on the face key point, to obtain the face image corresponding to the original image.

The foregoing sample video includes the original image, or may include a background image other than the original image. The original image includes an image corresponding to a face region that does not include the defect element, for example, an image corresponding to a face character having a relatively clean face and no acne in a film or television work. The background image includes another region other than the face region that does not include the defect element, which may be for example a tree, a vehicle, or a road.

The foregoing preset face resolution may be customized. For example, when the sample video is in HD, the preset face resolution may be set to 512*512. When the sample video is in full HD, the preset face resolution may be set to 1024*1024. The foregoing blurred video frame refers to a video frame whose image resolution is below a preset threshold, which may be for example an image having a display picture with a relatively low definition.

In some embodiments, during the face recognition and the key point detection performed on the sample video corresponding to the original image based on the preset face resolution, a candidate face region corresponding to the original image that does not include the defect element may be obtained through face preprocessing and motion information based on the preset face resolution and based on the face detection through histogram statistical learning. The face key point corresponding to each video frame in the sample video is determined through a face detection algorithm to accurately locate the face. The face corresponding to each video frame is compared with the candidate face region, to obtain the video frame corresponding to the face which has a perfect match. The video frame is used as a reference video frame conforming to the face resolution, and the face key point corresponding to the reference video frame is determined, so as to implement the face recognition based on the face detection of the original image in the video, thereby obtaining the reference video frame conforming to the face resolution and the corresponding face key point.

In some embodiments, an original image feature corresponding to the original image may also be determined, the original image feature is used as a face template, and the face template is matched with the image in each video frame in the sample video by using a template-based matching method. The video frame in the sample video that matches the face template may be determined by matching the face template with a feature such as a face scale, a face pose, or a face shape of the image corresponding to the image in each video frame, and the matching video frame is selected based on the preset face resolution, thereby determining the reference video frame conforming to the face resolution and having the matching image feature, and determining the face key point corresponding to the reference video frame.

After the reference video frame is obtained, the blurred video frame in the reference video frame may be filtered through an image quality evaluation model, to obtain a target video frame. The image quality evaluation model is configured to evaluate blurriness of each video frame. Each reference video frame may be inputted into the image quality evaluation model to score the blurriness, so as to obtain an output value. The reference video frame whose output value is greater than a threshold is used as a blurred video frame, the blurred video frame is filtered, and the remaining video frames in the reference video frame are used as the target video frames. In addition, due to a relatively small difference among several consecutive picture frames in the sample video, to improve diversity of the training sample, only one of a plurality of adjacent video frames of the target video frames may be retained. For example, only one of five adjacent video frames of the target video frames is retained.

In some embodiments, after the target video frame is obtained, the target video frame may be cropped based on the face key point, to obtain cropped face images. Alignment is performed on the cropped face images by using the face key points, to obtain an intermediate sample image. The intermediate sample image is processed through a super-resolution network, to obtain the face image corresponding to the original image. A resolution of the face image is greater than a resolution of the intermediate sample image.

The foregoing super-resolution network is configured to increase the resolution of the image. A multiple of the resolution increased by the super-resolution network may be customized, which may be for example 2, 3, 4, or 5.

The face region of the target video frame may be recognized based on the face key point, the recognized face region is cropped to obtain cropped face images, and the cropped face image is uniformly adjusted to have a preset face resolution. The alignment is performed on the cropped face images based on the face key points, to obtain an intermediate sample image conforming to the face resolution. A resolution of the intermediate sample image is increased through the super-resolution network, to obtain the face image corresponding to the original image. For example, when the resolution of the intermediate sample image is H*W, the resolution is increased by twice through the super-resolution network, and the resolution of the obtained face image is 2H*2W.

In some embodiments, after the defect element sample and the face image corresponding to the original image are obtained, a process of adding one of the defect element samples to the face image to obtain the training sample includes: selecting N defect elements from the plurality of defect element samples based on a preset defect selection strategy, N being a positive integer, selecting N positions in a face region of the face image based on a preset position selection strategy, and adding the N defect elements to the N positions of the face image, to obtain the training sample corresponding to the face images; and using the face image corresponding to the original image as the label image. For example, the preset defect selection strategy may be random selection, or selection of at least one defect on a face. The preset position selection strategy may be random selection, or selection based on a position where a defect may appear. For example, a defect element such as a pimple may appear on a position such as a forehead or a check and around a mouth.

The face image may be parsed to recognize a face region such as a face, a nose, or a forehead in the face image. A quantity of defect elements to be added is determined, for example, the quantity is in an interval of (1, h). A positive integer N is determined from the interval as the quantity of defect elements to be added. N defect elements are randomly selected from a plurality of defect element samples. Types, shapes, and sizes of the N defect elements may be different, and N positions are randomly selected in the face region such as the face, the nose, or the forehead in the face image. The N defect elements are added to the N positions of the face image in a manner of image fusion, to obtain the training sample corresponding to the face images.

l is less than h, and both l and h are positive integers. l refers to a minimum quantity of defect elements to be added, and h refers to a maximum quantity of defect elements to be added. The interval may be customized. N is greater than or equal to 1, and N is less than or equal to h.

In some embodiments, the foregoing manner of image fusion may be pixel-level image fusion, feature-level image fusion, and decision-level image fusion.

The pixel-level image fusion may operate and process image data at an image pixel level, belongs to a level of image fusion, and may include an algorithm such as principal component analysis (PCA) and pulse coupled neural networks (PCNN).

The feature-level image fusion belongs to an intermediate-level fusion. In the method, dominant feature information of each image is targetedly extracted based on the existing imaging characteristics of each sensor, for example, an edge and a texture, and may include algorithms such as fuzzy clustering and support vector clustering.

The decision-level image fusion belongs to a high-level fusion. Compared with the feature-level image fusion, the decision-level image fusion is to process a source image after extracting a target feature of an image, and feature recognition and decision classification are performed. Chain inference is performed based on decision information of each source image, to obtain an inference result. The decision-level image fusion may include algorithms such as an SVM and a neural network. The decision-level fusion is an advanced image fusion technology, and may use high data quality and high algorithmic complexity. For example, N defect elements may be added to N positions of the face image in a manner of Poisson fusion. Referring to FIG. 11, a label image is on a right side. After a defect is added to the label image, a corresponding training sample on a left side is obtained. The training sample includes a defect element sample.

A model training process and a model application process provided in some embodiments may be performed on different devices, or may be performed on the same device. The device may perform only the model training process, or may perform only the model application process. In a scenario where the device performs only the model application process, a model may be executed by another device (for example, some third-party platforms for model training). The device may obtain a model file from another device, execute the model file locally to implement the model application process described in some embodiments, and convert an image of an inputted model to obtain an image that does not include a defect element.

In some embodiments, a plurality of original images and a plurality of defect element samples are obtained, and face detection is performed on each of the original images, to obtain the face image corresponding to the original image. The defect element sample is added to the face image, to obtain a training sample and a label image, thereby providing accurate guidance information for training of the GAN. The image processing model with higher accuracy may be trained, and the trained image processing model may process a face image to be processed having a face distortion degree less than the preset threshold and including the defect element. Therefore, image conversion can be performed at a finer granularity, and the target face image may have characteristics such as a skin texture closer to those of a real face, thereby improving accuracy of performing the image conversion on the face image to be processed.

An image processing method provided in some embodiments is further described below.

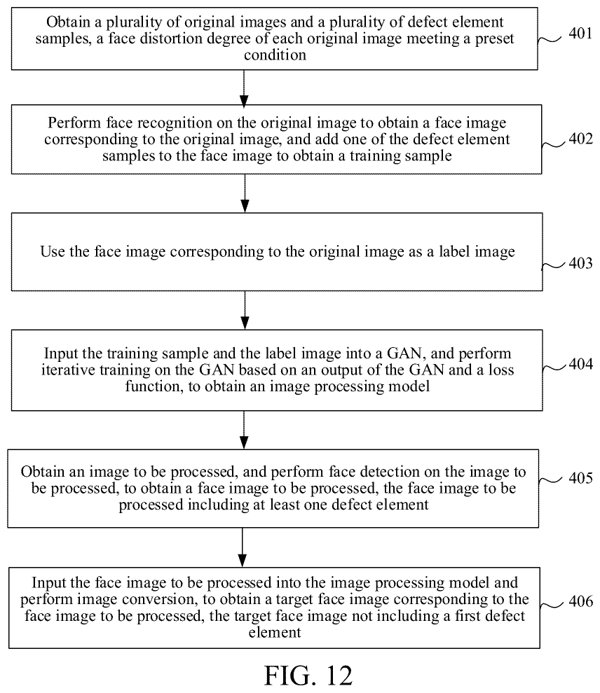

FIG. 12 is a schematic flowchart of a training method of an image processing model and an image processing method according to some embodiments. As shown in FIG. 12, the method may include the following operations.

401: Obtain a plurality of original images and a plurality of defect element samples, a face distortion degree of each of the original images meeting a preset condition.

402: Perform face recognition on the original image to obtain a face image corresponding to the original image, and add one of the defect element samples to the face image to obtain a training sample.

403: Use the face image corresponding to the original image as a label image.

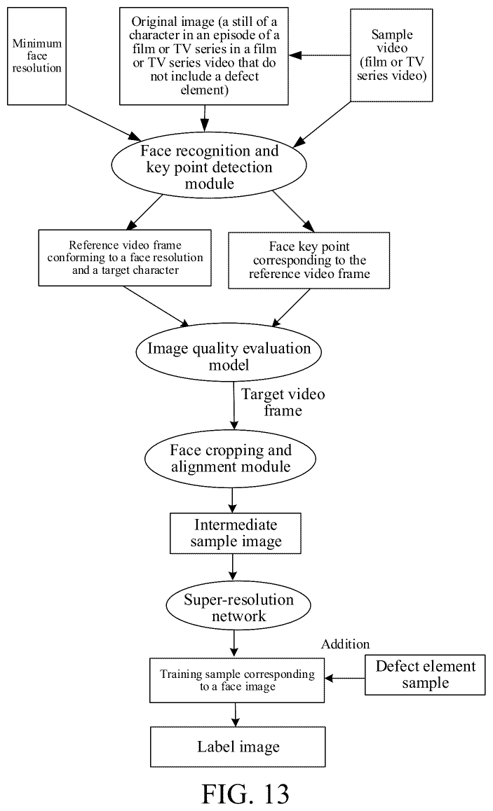

As shown in FIG. 13, a sample video may be obtained. The sample video includes a plurality of original images, and a face distortion degree of the original images meets the preset condition. The face distortion degree may be less than a preset threshold. The sample video is, for example, a video of an episode of a film or a television play. A plurality of characters with relatively clean and flawless faces in the episode of the video of the film or the television play are determined, and a still of each character role is determined from the video of the episode of the film or the television play as the original image.

For the foregoing defect element samples, for example, the plurality of defect element samples may be obtained by obtaining a historical face image including the defect element, recognizing the defect element on the historical face image, and intercepting a region including the defect element.

After the original image is obtained, a minimum face resolution H*W may be determined. For example, in an HD scene, H*W is 512*512. Face recognition and key point detection are performed on the original image, the minimum face resolution 512*512, and the sample video. A reference video frame conforming to the face resolution and a corresponding face key point may be determined through inputs to a face recognition module and a key point detection module. The key point detection module may output a reference video frame including a target character and a resolution of a face region of the target character and a corresponding face key point file.

Then each reference video frame may be inputted into an image quality evaluation model to score the blurriness, so as to obtain an output value. The reference video frame whose output value is greater than a threshold is used as a blurred video frame, the blurred video frame is filtered, and the remaining video frames in the reference video frame are used as target video frames. In addition, to improve diversity of the training sample, only one of five adjacent video frames of the target video frames may be retained.

After the target video frame is obtained, the target video frame may be inputted into a face cropping and alignment module. A face region of the target video frame may be recognized based on the face key point, the recognized face region is cropped to obtain cropped face images, and the cropped face images are uniformly adjusted to have a preset face resolution H*W of 512*512. The alignment is performed on the cropped face images based on the face key points, to obtain an intermediate sample image conforming to the face resolution 512*512. A resolution of the intermediate sample image is increased by twice through the super-resolution network, to obtain the face image corresponding to the original image. The resolution 2H*2W of the face image is 1024*1024.

Each face image may be parsed to recognize a face region such as a face, a nose, or a forehead in the face image, and a quantity of defect elements to be added is determined. For example, the quantity is in a range of (l, h). For example, the interval is (2, 10), where 2 is a minimum quantity of defect elements to be added, and 10 is a maximum quantity of defect elements to be added, for example, a quantity of all defect samples that are obtained. 5 defect elements are selected from the defect element samples. Types, shapes, and sizes of the 5 defect elements may be different, and 5 positions are randomly selected in the face region such as the face, the nose, or the forehead in the face image. The 5 defect elements are added to the 5 positions of the face image in a manner of Poisson fusion. For example, the five defect elements include a first defect, a second defect, a third defect, a fourth defect, and a fifth defect. Each defect element corresponds to a different type, a different shape, and a different size. In the manner of Poisson fusion, the first defect and the second defect are added to a left face in the face image, the third defect and the fourth defect are added to a right face in the face image, and the fifth defect is added to the forehead in the face image, thereby obtaining a training sample corresponding to the face image. Similarly, the defect element is added to the remaining face image to obtain the training sample, and the face image corresponding to the original image is used as the label image.

The label image and the training sample corresponding to the label image are used as a paired dataset, and a GAN is trained through the paired dataset, thereby obtaining the image processing model. The label image is a sample that does not include the first defect element, and the training sample is a sample that includes the first defect element.

404: Input the training sample and the label image into a GAN, and perform iterative training on the GAN based on an output of the GAN and a loss function, to obtain the image processing model.

The foregoing GAN includes one generation model and three discrimination models. After the training sample is obtained, the training sample may be inputted into the generation model and image conversion is performed. The generation model may include a convolutional network and a deconvolutional network, the training sample may be successively subjected to feature extraction through the convolutional network to obtain a sample feature, and the sample feature may be restored through the deconvolutional network to obtain a synthesized image. The synthesized image is mapped back to a pixel space of an inputted training sample, which corresponds to a resolution of 1024*1024.

The synthesized image and the label image may be respectively inputted into the plurality of discrimination models, to obtain a discrimination result corresponding to each discrimination model. The discrimination result is configured for representing a probability that the synthesized image is the same as the label image.

When three discrimination models are respectively a first discrimination model, a second discrimination model, and a third discrimination model, the training sample is inputted into the generation model and image conversion is performed to obtain a synthesized image, and the synthesized image and the label image may be inputted into the first discrimination model, to obtain a first discrimination result. Downsampling is performed on the synthesized image having a resolution of 1024*1024 to obtain a first reconstructed image having a resolution of 512*512, and the first reconstructed image and the label image are inputted into the second discrimination model, to obtain a second discrimination result. Downsampling is performed on the first reconstructed image having the resolution of 512*512 again to obtain a second reconstructed image having a resolution of 256*256, and the second reconstructed image having the resolution of 256*256 and the label image are inputted into the third discrimination model, to obtain a third discrimination result.

The synthesized image and the label image are inputted into the first discrimination model. Feature extraction may be performed through the convolutional layer in the discrimination model to obtain sample features. The sample features are normalized based on a normal distribution through the normalization layer in the discrimination model, to filter noise features in the sample features and obtain a normalized feature. The normalized feature is inputted into the fully connected layer in the discrimination model to obtain a sample fully connected vector, and the sample fully connected vector is processed by using the activation function, to obtain a corresponding first discrimination result. Similarly, the same method may be used to input the first reconstructed image into the second discrimination model to obtain the second discrimination result, and input the second reconstructed image into the third discrimination model to obtain the third discrimination result.

Then a loss between the synthesized image and the training sample, a loss of the discrimination result, and a loss between the training sample and the label image are determined based on the synthesized image and each discrimination result, and a corresponding loss weight is assigned to each loss, and a total loss function may be obtained through the foregoing equation (6). The iterative training is performed on the generation model and each discrimination model based on minimization of the loss function, and the image processing model is determined based on a trained generation model.

In some embodiments, during the training of the GAN, the iterative training is performed by calculating a difference between the synthesized image and the label image and determining an error of an image by the discrimination model, and a network parameter of a generator is optimized through an adversarial training process of the generation model and the discrimination model, and the synthesized image may be close to a target.

405: Obtain an image to be processed, and perform face detection on the image to be processed, to obtain a face image to be processed, the face image to be processed including at least one defect element.

For this operation, reference may be made to the descriptions of operation 101 and operation 102 described above.

406: Input the face image to be processed into an image processing model and perform image conversion, to obtain a target face image corresponding to the face image to be processed, the target face image not including the first defect element.

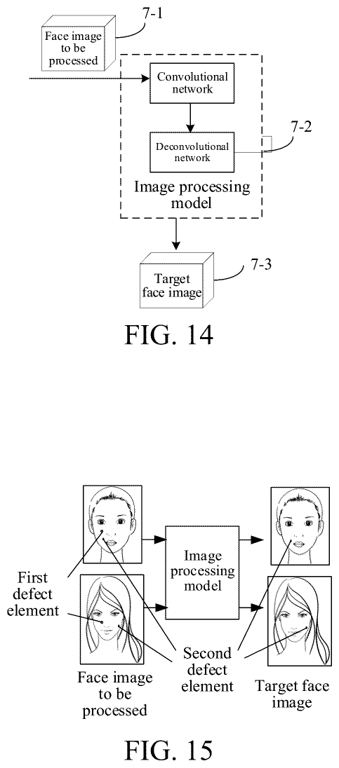

As shown in FIG. 14, after a face image 7-1 to be processed including the first defect element is determined, the face image 7-1 to be processed is inputted into a trained image processing model 7-2. The image processing model includes a convolutional network and a deconvolutional network. Feature extraction is performed through the convolutional network to obtain face features of the face image to be processed. The plurality of face features may include defect features and non-defect features. The defect features may be a mole and a pimple that are relatively similar. The non-defect features may be the remaining features other than the mole and the pimple amongst the face features such as a nose, a mouth, and eyebrows. The defect elements (the mole and the pimple) are screened to remove the target defect feature (the pimple), the remaining defect features (the mole) and all non-defect features are used as background features, and the background features are restored through the deconvolutional network, to obtain a target face image 7-3 in which only the target defect feature (the pimple) is removed and the remaining defect feature (the mole) and the remaining features (the face features such as the nose, the mouth, and the eyebrows) except the defect features are retained.

As shown in FIG. 15, an image on a left side is a face image to be processed that includes a first defect element (a pimple) and a second defect element (a mole). The first defect element (the pimple) is a defect element to be removed. After image conversion is performed through the image processing model, a target face image on a right side is obtained. In the target face image, the first defect element (the pimple) is removed, and the second defect element (the mole) is retained.

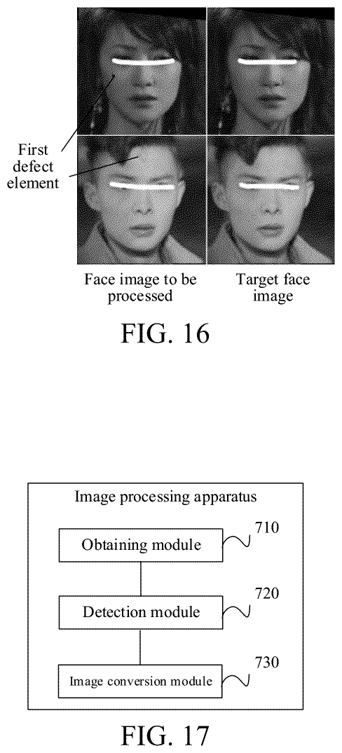

As shown in FIG. 16, an image on a left side is a face image to be processed including a first defect element (a pimple) acquired in a film or television play. An image on a right side is a target face image obtained after image conversion is performed, in which only the first defect element (the pimple) is removed, and the target face image may have a skin texture closer to that of a real face.

In some embodiments, the training sample of the image processing model uses a face image having a face distortion degree meeting a preset condition, and the trained image processing model may process the face image to be processed having the face distortion degree less than the preset threshold and including the defect element. The image conversion may be performed at a finer granularity, so as to obtain the target face image that does not include the defect element and that has characteristics such as a skin texture closer to those of a real face, thereby improving accuracy of performing the image conversion on the face image to be processed. In addition, the target face image may be applied to a post-processing system of a film or television work to accurately beautify the defect element of the face image to be processed, thereby greatly improving quality and efficiency of image processing.

Although the operations of the method in the present disclosure are described in an order in the accompanying drawings, this does not require or imply that the operations are bound to be performed in this order, or all the operations shown are bound to be performed to achieve the result. On the contrary, the execution order of the operations depicted in the flowchart may be changed, a plurality of operations may be merged into one operation for execution, and/or one operation may be decomposed into a plurality of operations for execution.

According to some embodiments, FIG. 17 is a schematic structural diagram of an image processing apparatus according to some embodiments. The apparatus may be a terminal device or an apparatus within a server. As shown in FIG. 17, the apparatus 700 includes:
an obtaining module 710, configured to obtain an image to be processed;
a detection module 720, configured to perform face detection on the image to be processed to obtain a face image to be processed, the face image to be processed including at least one defect element, the defect element referring to a skin element pre-specified on a face image; and
an image conversion module 730, configured to input the face image to be processed into an image processing model and perform image conversion, so as to obtain a target face image corresponding to the face image to be processed, the target face image not including a first defect element amongst the at least one defect element, and a training sample of the image processing model being a face image having a face distortion degree less than a preset threshold and annotated with the first defect element.

In some embodiments, the foregoing image conversion module 730 is further configured to:
input the face image to be processed into the image processing model and perform convolution, so as to obtain a plurality of face features, the face features including defect features and non-defect features;
screen the defect features, and remove a target defect feature corresponding to the first defect element amongst the defect features; and
use the remaining defect features and the non-defect features as background features, and perform deconvolution on the background features to obtain the target face image.

In some embodiments, a label image corresponding to the training sample is a face image including another element in the training sample other than the first defect element, and the image conversion module 730 is further configured to train the image processing model, including: inputting the training sample and the label image into a GAN, and performing iterative training on the GAN based on an output of the GAN and a loss function, to obtain the image processing model.

In some embodiments, the GAN includes a generation model and a discrimination model. The image conversion module 730 is configured to:
input the training sample into the generation model and perform image conversion, to obtain a synthesized image;
input the synthesized image and the label image into the discrimination model, to obtain a discrimination result, the discrimination result being configured for representing a probability that the synthesized image is the same as the label image;
construct the loss function based on a loss between the synthesized image and the training sample and a loss between the synthesized image and the label image; and
perform the iterative training on the generation model and the discrimination model based on the loss function, and determine the image processing model based on a trained generation model.

In some embodiments, the image conversion module 730 is further configured to:
generate a mask image corresponding to the training sample based on a position annotated with the first defect element in the training sample; and
annotate a defect region of each of the synthesized image and the label image based on the mask image, and determine the loss between the synthesized image and the label image.

In some embodiments, the foregoing image conversion module 730 is further configured to:
perform a multiplication operation on a mask matrix corresponding to the mask image and a pixel matrix corresponding to the synthesized image; and
perform the multiplication operation on the mask matrix corresponding to the mask image and a pixel matrix corresponding to the label image.

In some embodiments, during the construction of the loss function, the image conversion module 730 is further configured to determine the loss between the training sample and the label image.

In some embodiments, the loss between the training sample and the label image is determined based on the following relations:

$$α , ( 1 - α ) , x * M , x * ( 1 - M ) , G ( s ) * M , and G ( s ) * ( 1 - M ) ,$$

where s is the training sample, α is a loss weight corresponding to a region annotated with the first defect element, 1−α is a loss weight corresponding to another region except the region annotated with the first defect element, x*M is a region annotated with the first defect element in the label image, x*(1−M) is another region in the label image other than the region annotated with the first defect element, G(s)*M is a region annotated with the first defect element in the synthesized image, and G(s)*(1−M) is another region in the synthesized image other than the region annotated with the first defect element.

In some embodiments, the discrimination model includes at least one discrimination layer, and the loss between the synthesized image and the label image includes: a loss between a first intermediate processing result and a second intermediate processing result output by each of the discrimination layers, the first intermediate processing result being an intermediate processing result of each of the discrimination layers on the synthesized image, and the second intermediate processing result being an intermediate processing result of each of the discrimination layers on the label image.

In some embodiments, the obtaining module 710 is further configured to:
obtain a plurality of original images and a plurality of defect element samples, a face distortion degree of each of the original images being less than the preset threshold;
perform the face detection on the original image to obtain a face image corresponding to the original image, and add the defect element sample to the face image to obtain the training sample; and
use the face image corresponding to the original image as the label image.

In some embodiments, the obtaining module 710 is further configured to:
perform face recognition and key point detection on a sample video corresponding to the original image based on a preset face resolution, to determine a reference video frame conforming to the face resolution and a corresponding face key point;
filter a blurred video frame in the reference video frame to obtain a target video frame; and
crop the target video frame based on the face key point, to obtain the face image corresponding to the original image.

In some embodiments, the obtaining module 710 is further configured to:
crop the target video frame based on the face key points, to obtain cropped face images;
perform alignment on the cropped face images by using the face key points, to obtain an intermediate sample image; and
process the intermediate sample image through a super-resolution network to obtain the face image corresponding to the original image, a resolution of the face image being greater than a resolution of the intermediate sample image.

In some embodiments, the obtaining module 710 is further configured to:
select N defect elements from the plurality of defect element samples based on a preset defect selection strategy, N being a positive integer; and
select N positions in a face region of the face image based on a preset position selection strategy, and add the N defect elements to the N positions of the face image, to obtain the training sample corresponding to the face image.

For implementation details of the image processing apparatus, reference may also be made to the descriptions of the method according to some embodiments.

Based on the above, the image processing apparatus provided in some embodiments obtains the image to be processed through the obtaining module, performs the face detection on the image to be processed to obtain the face image to be processed including the defect element, and performs the image conversion processing by inputting the face image to be processed into the image processing model through the image conversion module, to obtain the target face image corresponding to the face image to be processed that does not include the defect element. Some embodiments may obtain the face image to be processed by recognizing the face region of the image to be processed, thereby providing guidance information for image conversion, so as to perform the image conversion on the face image to be processed in a targeted manner. The training sample of the image processing model may use the face image having the face distortion degree less than the preset threshold and annotated with the first defect element, and the corresponding label image may use a face image including another element in the training sample other than the first defect element, and the trained image processing model may process the face image to be processed having the face distortion degree less than the preset threshold and including the defect element. The image conversion may be performed at a finer granularity, so as to obtain the target face image that does not include the defect element and that has characteristics such as a skin texture closer to those of a real face, thereby greatly improving accuracy of performing the image conversion on the face image to be processed.

According to some embodiments, each module may exist respectively or be combined into one or more modules. Some modules may be further split into multiple smaller function subunits, thereby implementing the same operations without affecting the technical effects of some embodiments. The modules are divided based on logical functions. In application, a function of one module may be realized by multiple modules, or functions of multiple modules may be realized by one module. In some embodiments, the apparatus may further include other modules. In application, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

According to some embodiments, a device provided in some embodiments includes a memory, a processor, and a computer program stored in the memory and executable on the processor, the processor implementing the foregoing image processing method when executing the program.

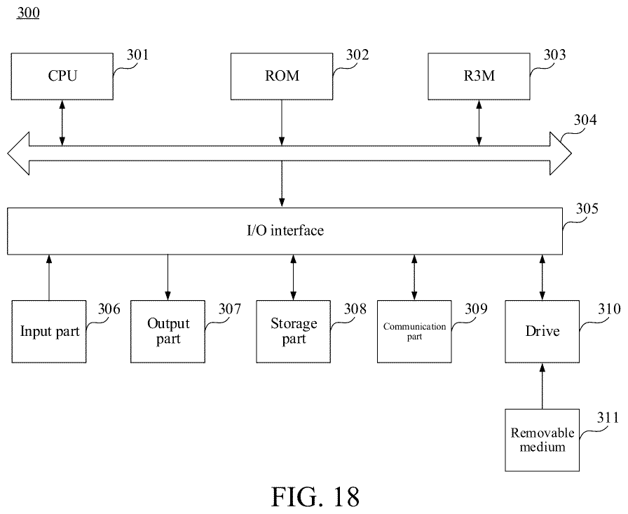

FIG. 18 is a schematic structural diagram of a computer system of a terminal device according to some embodiments.

As shown in FIG. 18, the computer system 300 includes a central processing unit (CPU) 301, which may perform various appropriate actions and processing based on a program stored in a read-only memory (ROM) 302 or a program loaded into a random access memory (RAM) 303 from a storage part 303. The RAM 303 further has various programs and data for operation of the system 300 stored therein. The CPU 301, the ROM 302, and the RAM 303 are connected to each other through a bus 304. An input/output (I/O) interface 305 is also connected to the bus 304.

The following components are connected to the I/O interface 305, for example, input parts 306 including a keyboard and a mouse; output parts 307 including a cathode ray tube (CRT), a liquid crystal display (LCD), a loudspeaker, and the like; the storage part 308 including a hard disk, or the like; and a communication part 309 including a network interface card such as a LAN card or a modem. The communication part 309 performs communication processing by using a network such as the Internet. A drive 310 may be connected to the I/O interface 305. A removable medium 311 such as a magnetic disk, an optical disk, a magneto-optical disk, or a semiconductor memory may be installed on the drive 310, and a computer program may read from the removable medium installed into the storage part 308.

According to some embodiments, the process described by referring to the flowchart in the above may be implemented as a computer software program. For example, some embodiments include a computer program product, the computer program product including a computer program carried on a machine-readable medium, the computer program including program code for performing the methods shown in the flowcharts. In some embodiments, the computer program may be downloaded from a network through the communication part 303 and installed, and/or installed from the removable medium 311. When the computer program is executed by the CPU 301, the foregoing functions defined in the system of some embodiments are performed.

The computer-readable medium in some embodiments may be a computer-readable signal medium or a computer-readable storage medium or any combination of the above. The computer-readable storage medium may be, for example, but is not limited to, an electric, magnetic, optical, electromagnetic, infrared, or semi-conductive system, apparatus, or device, or any combination of the above. An example of the computer-readable storage medium may include but is not limited to: an electrical connection by one or more wires, a portable computer disk, a hard disk, a RAM, a ROM, an erasable programmable ROM (EPROM or a flash memory), an optical fiber, a portable compact disk ROM (CD-ROM), an optical memory device, a magnetic memory device, or any appropriate combination of the above.

In some embodiments, the computer-readable storage medium may be any tangible medium including or storing a program. The program may be used by or in combination with an instruction execution system, apparatus, or device. In some embodiments, a computer-readable signal medium may include a data signal being in a baseband or propagated as a part of a carrier wave, which carries computer-readable program code. A data signal propagated in such a way may have a plurality of forms, including but not limited to, an electromagnetic signal, an optical signal, or any appropriate combination of the above. The computer-readable signal medium may further be any computer-readable medium other than the computer-readable storage medium. The computer-readable medium may send, propagate, or transmit the program used by or in combination with the instruction execution system, apparatus or device. The program code included in the computer-readable medium may be transmitted using a medium, including but not limited to, a wireless medium, a wired medium, an optical cable, RF, or the like, or a combination of the above.

The flowcharts and block diagrams in the accompanying drawings illustrate system architectures according to some embodiments, functions and operations that may be implemented by a system, a method, and a computer program product according to some embodiments. In this regard, each block in the flowchart or the block diagram may represent a module, a program segment, or part of code. The module, the program segment, or the part of the code described above includes one or more executable instructions for implementing specified logical functions. In some embodiments, functions annotated in the blocks may also be executed in a different order from those annotated in the accompanying drawings. For example, two boxes shown in succession may be performed in parallel, and the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

Some embodiments further provide a computer-readable storage medium. The computer-readable storage medium may be included in the electronic device described in the foregoing embodiments, or may exist alone without being installed into the electronic device. The foregoing computer-readable storage medium has one or more programs stored therein. The foregoing program is used by one or more processors to perform the image processing method described in some embodiments.

Based on the above, according to the image processing method and apparatus, the device, the storage medium, and the program product provided in some embodiments, the image to be processed is obtained, and the face detection is performed on the image to be processed, to obtain the face image to be processed. The face image to be processed includes at least one defect element. The face image to be processed is inputted into the image processing model and the image conversion is performed, to obtain the target face image corresponding to the face image to be processed that does not include the defect element. The training sample of the image processing model is the face image having a face distortion degree less than a preset threshold and annotated with the first defect element. The label image of the training sample is a face image including another element in the training sample other than the first defect element.

Some embodiments may obtain the face image to be processed by recognizing the face region of the image to be processed, thereby providing guidance information for image conversion, so as to perform the image conversion on the face image to be processed in a targeted manner. The training sample of the image processing model may use the face image having the face distortion degree less than the preset threshold and annotated with the first defect element, and the corresponding label image may use a face image including another element in the training sample other than the first defect element, and the trained image processing model may process the face image to be processed having the face distortion degree less than the preset threshold and including the defect element. The image conversion may be performed at a finer granularity, so as to obtain the target face image that does not include the defect element and that has characteristics such as a skin texture closer to those of a real face, thereby greatly improving accuracy of performing the image conversion on the face image to be processed. The solution may further be applied to a post-processing system of the film or television work to accurately beautify the defect element of the face image to be processed, greatly improving the quality and the efficiency of image processing and providing a strong support for presentation and analysis of the film or television work.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, performed by a computer device, comprising:
obtaining an input image to be processed;
performing face detection on the input image to obtain an input face image to be processed comprising at least one defect element relating to a skin element; and
inputting the input face image into an image processing model to obtain a target face image corresponding to the input face image without a first defect element amongst the at least one defect element,
wherein a training sample of the image processing model comprises a first face image with a first face distortion degree less than a preset threshold and that is annotated with the first defect element.

2. The image processing method according to claim 1, wherein the inputting the input face image comprises:
inputting the input face image into the image processing model and performing convolution to obtain a plurality of face features comprising one or more defect features and one or more non-defect features;
screening the one or more defect features, and removing a target defect feature of the one or more defect features corresponding to the first defect element; and
using remaining defect features of the one or more defect features other than the target defect feature and the one or more non-defect features as background features, and performing deconvolution on the background features to obtain the target face image.

3. The image processing method according to claim 1, wherein a label image corresponding to the training sample is a second face image comprising a second element in the training sample other than the first defect element, and
wherein training of the image processing model comprises:
inputting the training sample and the label image into a generative adversarial network (GAN); and
performing iterative training on the GAN based on an output of the GAN and calculating a loss value, to obtain the image processing model.

4. The image processing method according to claim 3, wherein the GAN comprises a generation model and a discrimination model, and
wherein the training of the image processing model comprises:
inputting the training sample into the generation model and performing image conversion, to obtain a synthesized image;
inputting the synthesized image and the label image into the discrimination model, to obtain a discrimination result representing a probability that the synthesized image is the same as the label image;
determining the loss value based on a first loss between the synthesized image and the training sample and a second loss between the synthesized image and the label image;
performing the iterative training on the generation model and the discrimination model based on the loss value; and
determining the image processing model based on a trained generation model.

5. The image processing method according to claim 4, further comprising:
generating a mask image corresponding to the training sample based on a position annotated with the first defect element in the training sample;
annotating a defect region of each of the synthesized image and the label image based on the mask image; and
determining the second loss.

6. The image processing method according to claim 5, wherein the annotating the defect region comprises:
performing multiplication on a mask matrix corresponding to the mask image and a first pixel matrix corresponding to the synthesized image; and
performing the multiplication on the mask matrix and a second pixel matrix corresponding to the label image.

7. The image processing method according to claim 5, wherein the determining the loss value comprises:
determining a third loss between the training sample and the label image.

8. The image processing method according to claim 7, wherein the third loss is determined based on a relation comprising:
$$α , ( 1 - α ) , x * M , x * ( 1 - M ) , G ( s ) * M , and G ( s ) * ( 1 - M ) ,$$
wherein s is the training sample,
wherein α is a first loss weight corresponding to a first region annotated with the first defect element, and 1−α is a second loss weight corresponding to a second region other than the first region,
wherein x*M is a third region annotated with the first defect element in the label image, and x*(1−M) is a fourth region in the label image other than the third region, and
wherein G(s)*M is a fifth region annotated with the first defect element in the synthesized image, and G(s)*(1−M) is a sixth region in the synthesized image other than the fifth region.

9. The image processing method according to claim 4, wherein the discrimination model comprises at least one discrimination layer, and the second loss comprises a third loss between a first intermediate processing result and a second intermediate processing result output by the at least one discrimination layer,
wherein the first intermediate processing result is based on processing the synthesized image via the at least one discrimination layer, and
wherein the second intermediate processing result is based on processing the label image via the at least one discrimination layer.

10. The image processing method according to claim 3, further comprising:
obtaining a plurality of original images and a plurality of defect element samples, wherein a second face distortion degree of the plurality of original images is less than the preset threshold;
performing the face detection on the plurality of original images to obtain a plurality of face images corresponding to the plurality of original images;
adding the plurality of defect element samples to the plurality of face images to obtain a plurality of training samples; and
using the plurality of face images as a plurality of label images.

11. An image processing apparatus, comprising:
at least one memory configured to store computer program code; and
at least one processor configured to read the program code and operate as instructed by the program code, the program code comprising:
obtaining code configured to cause at least one of the at least one processor to obtain an input image to be processed;
detection code configured to cause at least one of the at least one processor to perform face detection on the input image to obtain an input face image to be processed comprising at least one defect element relating to a skin element; and
image conversion code configured to cause at least one of the at least one processor to input the input face image into an image processing model to obtain a target face image corresponding to the input face image without a first defect element amongst the at least one defect element,
wherein a training sample of the image processing model comprises a first face image with a first face distortion degree less than a preset threshold and that is annotated with the first defect element.

12. The image processing apparatus according to claim 11, wherein the image conversion code is configured to cause at least one of the at least one processor to:
input the input face image into the image processing model and perform convolution to obtain a plurality of face features comprising one or more defect features and one or more non-defect features;
screen the one or more defect features, and remove a target defect feature of the one or more defect features corresponding to the first defect element; and
use remaining defect features of the one or more defect features other than the target defect feature and the one or more non-defect features as background features, and perform deconvolution on the background features to obtain the target face image.

13. The image processing apparatus according to claim 11, wherein a label image corresponding to the training sample is a second face image comprising a second element in the training sample other than the first defect element,
wherein the program code further comprises training code configured to cause at least one of the at least one processor to train the image processing model, and
wherein the training code is configured to cause at least one of the at least one processor to:
input the training sample and the label image into a generative adversarial network (GAN); and
perform iterative training on the GAN based on an output of the GAN and calculating a loss value, to obtain the image processing model.

14. The image processing apparatus according to claim 13, wherein the GAN comprises a generation model and a discrimination model, and
wherein the training code comprises first input code, second input code, first determining code, performing code, and second determining code,
wherein the first input code is configured to cause at least one of the at least one processor to input the training sample into the generation model and perform image conversion, to obtain a synthesized image,
wherein the second input code is configured to cause at least one of the at least one processor to input the synthesized image and the label image into the discrimination model, to obtain a discrimination result representing a probability that the synthesized image is the same as the label image,
wherein the first determining code is cause at least one of the at least one processor to determine the loss value based on a first loss between the synthesized image and the training sample and a second loss between the synthesized image and the label image,
wherein the performing code is cause at least one of the at least one processor to perform the iterative training on the generation model and the discrimination model based on the loss value, and
wherein the second determining code is configured to cause at least one of the at least one processor to determine the image processing model based on a trained generation model.

15. The image processing apparatus according to claim 14, wherein the training code further comprises generating code, annotating code, and third determining code,
wherein the generating code is configured to cause at least one of the at least one processor to generate a mask image corresponding to the training sample based on a position annotated with the first defect element in the training sample,
wherein the annotating code is configured to cause at least one of the at least one processor to annotate a defect region of each of the synthesized image and the label image based on the mask image, and
wherein the third determining code is configured to cause at least one of the at least one processor to determine the second loss.

16. The image processing apparatus according to claim 15, wherein the annotating code is configured to cause at least one of the at least one processor to:
perform multiplication on a mask matrix corresponding to the mask image and a first pixel matrix corresponding to the synthesized image; and
perform the multiplication on the mask matrix and a second pixel matrix corresponding to the label image.

17. The image processing apparatus according to claim 15, wherein the first determining code is configured to cause at least one of the at least one processor to determine a third loss between the training sample and the label image.

18. The image processing apparatus according to claim 17, wherein the third loss is determined based on a relation comprising:
$$α , ( 1 - α ) , x * M , x * ( 1 - M ) , G ( s ) * M , and G ( s ) * ( 1 - M ) ,$$
wherein s is the training sample,
wherein α is a first loss weight corresponding to a first region annotated with the first defect element, and 1−α is a second loss weight corresponding to a second region other than the first region,
wherein x*M is a third region annotated with the first defect element in the label image, and x*(1−M) is a fourth region in the label image other than the third region, and wherein G(s)*M is a fifth region annotated with the first defect element in the synthesized image, and G(s)*(1−M) is a sixth region in the synthesized image other than the fifth region.

19. The image processing apparatus according to claim 14, wherein the discrimination model comprises at least one discrimination layer, and the second loss comprises a third loss between a first intermediate processing result and a second intermediate processing result output by the at least one discrimination layer,
wherein the first intermediate processing result is based on processing the synthesized image via the at least one discrimination layer, and
wherein the second intermediate processing result is based on processing the label image via the at least one discrimination layer.

20. A non-transitory computer-readable storage medium, storing computer code which, when executed by at least one processor, causes the at least one processor to at least:
obtain an input image to be processed;
perform face detection on the input image to obtain an input face image to be processed comprising at least one defect element relating to a skin element; and
input the input face image into an image processing model to obtain a target face image corresponding to the input face image without a first defect element amongst the at least one defect element,
wherein a training sample of the image processing model comprises a first face image with a first face distortion degree less than a preset threshold and that is annotated with the first defect element.
